(19) United States
(12) Patent Application Publication
(10) Pub. No.: US 2026/0214536 A1
(43) Pub. Date: Jul. 23, 2026

(54) SYSTEM AND METHOD FOR ENABLING MIGRATION OF USER EQUIPMENT TO A CLOSED SUBSCRIBER GROUP LAYER

(71) Applicant: BADAWI YAMINE, Hazmieh (LB)

(72) Inventor: BADAWI YAMINE, Hazmieh (LB)

(21) Appl. No.: 19/453,223

(22) Filed: Jan. 20, 2026

(30) Foreign Application Priority Data
Jan. 20, 2025 (IN) 202511004522

(51) Int. Cl. H04W 36/04; H04W 4/90; H04W 8/18; H04W 84/06

(52) U.S. Cl. CPC H04W 36/04; H04W 4/90; H04W 8/183; H04W 84/06

(57) ABSTRACT

This disclosure presents systems and methods for enabling User Equipment (UE) migration to Closed Subscriber Group (CSG) layers. Key techniques include selectively broadcasting the frequency used by CSG cell layers on public cells only to registered UEs, suppressing such frequency announcements when a CSG cell or layer becomes unavailable, facilitating seamless UE mobility between different CSG layers, temporarily converting a CSG cell to open access mode following a dangerous incident, and, in the event of equipment failure, temporarily opening a CSG cell exclusively to specific authorized UEs while keeping it restricted for others.

### PRIORITY PARAGRAPH

This application claims priority to IN Provisional Patent 202511004522 filed on Jan. 20, 2025, which is incorporated herein by reference in its entirety.

### FIELD OF INVENTION

The embodiments of the present disclosure generally relate to telecommunication deployment. More particularly, the present disclosure relates to a system and a method for enabling migration of User Equipment (UE) to Closed Subscriber Group (CSG) layer.

### BACKGROUND

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

A low power radio base station, also called Home (e)NB (Node B), or HeNB, is used indoor and it brings many advantages. In one example, HeNB overcomes the issue of indoor radio penetration loss. The access to the HeNB could be one of the following three modes: Closed access: Only registered UEs to the HeNB, also called members, are allowed to connect to the HeNB. The closed access mode is also called as Closed Subscriber Group (CSG). Open access: All subscribers that receive radio coverage from one HeNB can make any type call on that HeNB. Hybrid access: All users have access to the HeNB however the subscribers that are members of the CSG of the HeNB might get priority or different charging rates as compared with non-CSG UEs.

Actually, the network of any mobile wireless operator, e.g. operator 1, is usually composed of different radio technology layers, e.g. at the same operator there is one layer of 2G cells and another layer of 3G cells and yet another layer of 4G cells and so on. Any subscriber that is registered to that operator 1, depending on the capability of his mobile phone and on his subscription profile, could access all these layers of cells. In the present disclosure, all the existing layers of cells belonging to one operator, such as operator 1 in our example, are called public cells because they could be accessed by all the subscribers of that operator. Considering that, in the present disclosure an additional layer of private cells, also denoted as a layer of CSG cells, is created on top of the public cells over a large area, or over the whole network. Similar to the case of HeNB, a layer of CSG cell could work in three modes: CSG, open access and Hybrid access. These private cells could provide additional services to any registered subscriber in return to a certain fee. Such layer of CSG cells is composed of multiple CSG cells that are adjacent to each other and that cover a large geographical area. This is not the case of existing CSG cells which are used as isolated cells with a few hundred meters of radio coverage range and that are implemented in a separate and distant locations, e.g. at the subscriber house or in a mall or at a work office and the like.

Such new layer of CSG cells may be composed of any type of RAT (Radio Access Technology). In a first example, it could be composed of a layer that provides broadband, e.g. via wifi or any other non 3GPP (Third Generation Partnership Project) RAT. In a second example, it could be composed of any coming or future RAT such as 6G. In a third example, it could be composed of a non-terrestrial layer of cells. In a fourth example, it could be composed of a layer of a cells belonging to a second operator, e.g. operator 2, where some subscribers of operator 1 might be registered to such roaming layer. In a fifth example, it could be composed of a private layer of existing RAT at operator 1, e.g. operator 1 create an additional private layer of 5G or 6G where only some subscribers are registered to. It should be noted that the same UE could be registered to multiple layers of CSG cells, e.g. a UE is registered to a first terrestrial CSG layer running on wifi and also it is registered to a second layer of non-terrestrial CSG cells.

The CSG cells, such as HeNB, are usually run on a different frequency than the ones run on the public network. This is done to avoid interference between the radio coverage coming from public base stations implemented outside the house and the radio coverage coming from the base station of the CSG cell implemented inside the house. As a consequence, to move from a public cell to a CSG cell and vice versa, the UE has to know the frequency of the target cell to perform inter-frequency radio measurements before moving to it. Similarly, in the present disclosure public cells and every layer of CSG cells are running on different frequencies. To let the UE know the frequency of the target cell, different methods are used which are classified into two scenarios in the present disclosure. In a first scenario, the first cell on which the UE is being served does not broadcast the frequency of the second cell to which the UE wants to move. In a second scenario, the first cell on which the UE is being served broadcasts the frequency of the second cell to which the UE wants to move. Note that when a cell broadcasts an information that information will reach all UEs in the cell.

In the first scenario, actual CSG cells are isolated and covering a very small area. As a result, even though when a macro public cell, covering a large area and running on a first frequency, is overlapping a second CSG micro cell, running on a second frequency, the public cell does not broadcast the frequency of the CSG cell because only one or just a few UEs in the public cell are registered to the isolated CSG cell. Instead other standards procedures are used. In a first procedure when a UE is in idle mode, the move from a public cell to a micro CSG cell is based on a UE autonomous search function. In a second procedure when a UE is in connected mode, then once it approaches the location of the micro CSG cell, e.g. the subscriber's home, it will inform the serving public cell about such event by sending the RRC message, ProximityIndication, where it indicates to the public cell that it is entering the area of the CSG cell and as a result the public cell will may then configure the UE to perform radio measurements on the CSG cell frequency and then report back the results of these measurements.

Further, as it is proposed in the present disclosure, the CSG cells are not micro cells located at separate locations with public cells in between them. Rather CSG cells are macro cells belonging to one layer of CSG cells and they are adjacent to each other. As a consequence, the two standard procedures used in the first scenario above, the UE autonomous search and the ProximityIndication, are not efficient as they will be performed at each CSG cell of the many adjacent CSG cells belonging to one layer which leads to unnecessary signaling and battery consumption. Instead, the second scenario that consists of broadcasting on the public cell the second frequency of CSG cell might be used. However, such action will cause two main problems. A first problem is that when the first public cell broadcast the second frequency of the second CSG cell, that frequency will reach all UEs in the public cell irrespective these UEs are registered to the CSG cells or not. Moreover, based on the UE standards, for a UE to move from a first cell, e.g. a public cell, running on a first frequency to a second cell, e.g. a CSG cell, running on a second frequency it should perform inter-frequency radio measurements according to the following two formulas extracted from specification 38.133:
“If Srxlev>SnonIntraSearchP and Squal>SnonIntraSearchQ then the UE shall search for inter-frequency layers of higher priority at least every Thigher_priority_search.
If Srxlev≤SnonIntraSearchP or Squal≤SnonIntraSearchQ then the UE shall search for and measure inter-frequency layers of higher, equal, or lower priority in preparation for possible reselection.”
   As a consequence, once the CSG cell frequency is broadcasted on the public cell, a second problem consists of allowing registered UEs to move from the public cell to the CSG cell while respecting the above two standards formulas.

Further on, actually, if a UE is not registered to a CSG cell then it could not perform normal calls on that CSG cell. The access of the UE to a CSG cell depends on the RAT that is running on that CSG cell. Suppose that a UE, e.g. UE1, is registered to a public cell running on a 5G RAT while it is unregistered to a CSG cell, e.g. CSG cell1, which could be a terrestrial or non-terrestrial cell. If CSG cell1 is running on a wifi RAT then UE1 could not access at all CSG cell1 whereas if CSG cell1 is running on a 5G RAT then UE1 could perform only emergency call on CSG cell1. In case a dangerous incident that could impact human' life occurs, such as a natural disaster or a fire or a biological sensor etc . . . , and in case the public cell becomes unavailable then even if CSG cell1 is available then actually either UE1 could not perform any call on it or it could perform only an emergency call on it. In other words, actually, a CSG cell is not converted to an open access cell when a dangerous incident occurs so that unregistered UEs which are in danger could perform normal calls on the CSG cell and this is considered as the third problem that is disclosed in the present disclosure.

Therefore, there is a need in the art to provide a system and a method for enabling migration of a UE to a CSG layer, that can overcome the shortcomings of the existing prior art.

### OBJECTS OF THE PRESENT DISCLOSURE

Some of the objects of the present disclosure, which at least one embodiment herein satisfies are as listed herein below.

An object of the present disclosure is to provide a system and methods for enabling migration of a User Equipment (UE) to a Closed Subscriber Group (CSG) layer.

An object of the present disclosure is to provide a system and methods that allow a mobile wireless operator to create a new layer of CSG cells on top of its existing public cell where registered UEs could access the service of the layer of CSG cells in return of certain fees while that same layer of CSG cells looks transparent for unregistered UEs.

An object of the present disclosure is to provide a system and methods that allow a subscriber to switch from a first layer to second layer based on based on a software icon, the artificial intelligence technique, and a mobile application and where the first and the second layers could be any of a public cell and a layer of CSG cells.

An object of the present disclosure is to provide a system and methods that allow an unregistered UE to access a layer of CSG cells after the occurrence of a dangerous incident that could impact subscriber's life.

An object of the present disclosure is to allow an unregistered UE, based on its SIM (Subscriber Identity Module) card and geographical location, to access a layer of CSG cells after an equipment failure.

### SUMMARY

This section is provided to introduce certain objects and aspects of the present disclosure in a simplified form that are further described below in the detailed description. This summary is not intended to identify the key features or the scope of the claimed subject matter.

In an aspect, the present disclosure provides system for enabling migration of a User Equipment (UE) to a Closed Subscriber Group (CSG) layer. The system may include at least one public cell, and one or more layer of CSG cells coupled to the at least one public cell. The one or more layer of CSG cells may be configured to provide a plurality of services to one or more UE's within the one or more layer of CSG cells. The system may include one or more UE communicatively coupled to the at least one public cell and the one or more layer of CSG cells. The UE may be configured to utilize one or more network resources and access the plurality of services to perform one or more operations. The one or more UE may include at least one of the one or more registered UE and the one or more unregistered UE. The system may include one or more processors coupled with a memory. The memory stores instructions which when executed by the one or more processors causes the system to manage migration of the one or more registered UE from the at least one public cell to the one or more layer of CSG cells based on communicating information of a pre-defined frequency. Furthermore, the system may be configured to broadcast the information of the pre-defined frequency via the at least one public cell to the one or more UE in based on one or more conditions. The one or more registered UE may be configured to validate the one or more conditions, and the one or more unregistered UE is configured to overlook the information. The system may be configured to store the information of the pre-defined frequency of the one or more layer of CSG cells on the SIM card of the one or more registered UE. The system may be configured to transmit the information of the pre-defined frequency to the one or more registered UE by using a dedicated signaling message triggered by the at least one public cell by a fallback procedure. The system may be configured to transmit via the at least one public cell to the one or more registered UE the type of a Radio Access Technology (RAT) that is running on the layer of CSG cells, and the one or more registered UE is configured to scan one or more frequencies associated with the RAT. Finally, the system may be configured to receive the communicated pre-defined frequency information by the one or more registered UE to perform one or more radio measurements and enable migration of the one or more registered UE to the one or more layer of CSG cells.

In an embodiment, the one or more layer of CSG cells comprise one or more micro-CSG cells positioned adjacent to each other to provide a wide range of radio coverage to the one or more registered UE. The information of the pre-defined frequency comprises a value of frequency used by each of the one or more micro-CSG cells belonging to the one or more layer of CSG cells and the priority of the pre-defined frequency. A CSG cell could be running on any type of radio access technology and it could belong to a terrestrial or to a non-terrestrial wireless network. The one or more UE is configured to registered to a multiple number of the one or more layer of CSG cells, and detect the identity of each layer based on the information stored on the SIM card.

In an embodiment, the system may be configured to broadcast the information of the one or more layer of CSG cells by using the at least one public cell based on a count of the one or more layer of CSG cells available, the identity of each layer of one or more micro-CSG cells and information related to the pre-defined frequency associated with the one or more layer of CSG cells the priority of the pre-defined frequency of the one or more layer of CSG cells is higher than the priority of the pre-defined frequency of the at least one public cell. The one or more registered UE is configured to access content of the broadcasted information to migrate from the at least one public cell to the one or more CSG layer of CSG cells, where the one or more unregistered UE is configured to overlook the content of the new broadcasted information.

In an embodiment, the system may be configured to broadcast the information by using the at least one public cell based on the priority of the pre-defined frequency of the one or more layer of CSG cells is higher than the priority of the pre-defined frequency of the at least one public cell. The system may be configured to store the information of the pre-defined frequency used by each of the one or more layer of CSG cells on the SIM card of the one or more registered UE registered. The one or more registered UE registered may be configured to collect a pre-defined frequency information pertaining to a target CSG layer, and store the pre-defined frequency information in a UE database during a first time access and perform one or more radio measurements and enable migration of the one or more registered UE to the one or more layer of CSG cell.

In an embodiment, the system may be configured to broadcast the information of the one or more layer of CSG cells by using the at least one public cell based on a count of the one or more layers of CSG cells available, the identity of each layer of CSG cells and information related to the pre-defined frequency associated with the one or more layer of CSG cells. Further, the priority of the pre-defined frequency of the one or more layer of CSG cells is lower than the priority of the pre-defined frequency of the at least one public cell. The one or more registered UE is configured to transmit a call request signal to the at least one public cell to access the target CSG layer, the at least one public cell rejects the call request signal comprising information related to the pre-defined frequency the radio access technology of the target layer of CSG cells.

In an embodiment, the system may be configured to broadcast the information of the one or more layer of CSG cells by using the at least one public cell based on a count of the one or more layers of CSG cells available, the identity of each layer of CSG cells and information related to the pre-defined frequency associated with the one or more layer of CSG cells. Further, the system may be configured to broadcast the information based on the priority of the pre-defined frequency of the one or more layers of CSG cells is higher than the priority of the pre-defined frequency of the at least one public cell. The system may be configured to communicate to the UE the RAT of each available layer of the one or more layer of CSG cells by broadcasting using the at least one public cell or by storing the value on the SIM cards of each of the one or more registered UE to a layer of CSG cells. The information of the pre-defined frequency is deduced by the one or more registered UE based on scanning the one or more frequencies associated with the RAT to detect the suitable cell on the one or more layer of CSG cell and then store the pre-defined frequency associated with the information on the UE database.

In an embodiment, the system may be configured to whenever the one or more CSG cell belonging to a layer of CSG cells is completely overlapping on the at least one public cell the system comprises at least one of a first scenario and a second scenario. The first scenario comprises broadcasting the multiple number of the one or more layer CSG cells associated with the identity of the one or more micro-CSG cells by the at least one public cell. Each time the one or more overlapping of CSG cell becomes unavailable, the at least one public cell is configured to stop broadcasting the identity associated with the one or more layer of CSG cells, and decreases the value of the multiple number of the one or more available layers of CSG cells by one count. Each time the one or more overlapping CSG cell becomes available, the at least one public cell is configured to broadcasting the identity associated with the one or more layer of CSG cells and increase the value of the multiple number of the one or more available layers of CSG cells by one count.

Further, the second scenario comprises not broadcasting the multiple number of the one or more layer of CSG cells associated with the identity of the one or more micro-CSG cells by the at least one public cell. The one or more registered UE is configured to access the one or more layer of CSG cells from the at least one public layer based on the signalling message associated with a timer. The one or more registered UE is configured to predict a faulty state of the one or more layer of CSG cells based on encountering overlapping by using an Artificial Intelligence (AI) technique, and then search for the one or more layer CSG cells which is suitable based on the pre-defined frequency over a predefined period of time.

In an embodiment, the system may be configured to enable migration of the one or more registered UE from a first CSG layer to a second CSG layer based on the priority of the pre-defined frequency set by the one or more registered UE. The priority of the pre-defined frequency of the second CSG layer is set higher than the priority of the frequency used on the first CSG layer.

In an embodiment, the UE may be configured to enable the triggering of the priority of the pre-defined frequency comprises based on a software icon, the artificial intelligence technique, and a mobile application. The software icon on the one or more registered UE associated with the at least one subscriber to access the plurality of services associated with the one or more layer of CSG cells. The artificial intelligence technique implemented at the one or more registered UE to monitor the at least one subscriber's activity on each of the one or more layers of CSG cells. The mobile application comprises the software icon for activating the one or more layers of selected CSG cells which is activated from the one or more layers of available CSG cells along with a time-frame.

In an embodiment, the system may be configured to enable the one or more unregistered UE to perform one or more actions, such as a normal call, based on validating one or more factors comprising an occurrence of at least one dangerous incident, a detection of the identity of the at least one CSG cell impacted by the dangerous incident, and a conversion of the at least one detected CSG cells to an open access cells and enabling access to the one or more unregistered UE.

In an embodiment, the occurrence of any dangerous incident is detected using an operations and support unit coupled to an external server. The external server comprises at least one dangerous incident received from one or more sources comprising one or more sensors, a natural disaster monitoring system, a call center. The conversion of the at least one detected CSG cells to the open access cell is either executed for the all unregistered UEs being served by the detected CSG cells or for the one or more unregistered UEs selected based on the SIM and a terrestrial geographical location. The detected CSG cell is reverted back from the open access to a CSG cell immediately after the dangerous incident is ceased or after a timer has expired and where the value of the timer is calculated based on a predefined value configured by the wireless network operator or based on an artificial intelligence technique to set dynamically the value of that timer based on previous experience with such dangerous incident event

In an embodiment, the one or more sensors is coupled to at least one of a human body, a terrestrial geographical location, a non-terrestrial object. The sensor comprises: sending a sensor alarm notification after a dangerous incident has occurred and sending an early sensor alarm notification such as when a sub-threshold of the sensor alarm is reached or based on a sensor alarm prediction tool. The natural disaster monitoring system comprises a weather station and a seism monitoring center. The call center comprises any call coming from a subscriber who is reporting the occurrence of an accident.

In an embodiment, the system may be configured to convert of the one or more CSG cell to an open access cell based on detecting a particular UE associated with at least one of a specific SIM card and a particular location after the occurrence of an equipment failure. The equipment comprises a radio base station, an internet protocol router, a switch, a router and a transmission device. Further, inside the equipment is implemented a UE that has an access to a terrestrial wireless network and to a non-terrestrial mobile wireless network. Further, the system may be configured to revert back the one or more CSG cell from the open access to CSG cell immediately after the equipment failure is recovered or after a timer has expired and where the value of the timer could be calculated based on the predefined value configured by the wireless network operator or based on an artificial intelligence technique to set dynamically the value of that timer based on previous experience with such equipment failure event

In an embodiment, the access to a terrestrial wireless network and to a non-terrestrial mobile wireless network could be direct that is from the UE to the base station over the air interface and indirect that is from the UE to the base station via a second UE that is used as a relay. The connection of the equipment with the terrestrial wireless network comprises an incorporated UE, a fiber optical cable, a coaxial cable, an Ethernet cable, and a microwave device. The connection of the equipment with the non-terrestrial wireless network comprises an incorporated UE and an antenna for a satellite.

In an aspect, the present disclosure relates to a method for enabling migration of a UE to a CSG layer. The method includes the step of managing, by a system, migration of one or more registered UE from at least one public cell to one or more layers of CSG cells based on communicating information of a pre-defined frequency comprises broadcasting, by the system, the information of the pre-defined frequency via the at least one public cell to one or more UE in based on one or more conditions. The one or more registered UE is configured to validate the one or more conditions, and the one or more unregistered UE is configured to overlook information. Further, the method includes the step of storing, by the system, the information of the pre-defined frequency of the one or more layers of CSG cells on the SIM card of the one or more registered UE. Furthermore, the method includes the step of transmitting, by the system, using a dedicated signalling message triggered by the at least one public cell by a fallback procedure. The method includes the step of transmitting, by the system, via the at least one public cell to the one or more registered UE the type of a RAT that is running on the layer of CSG cells, and the one or more registered UE is configured to scan one or more frequencies associated with the RAT. Finally, the method includes the step of receiving, by the system, the communicated pre-defined frequency information by the one or more registered UE to perform one or more radio measurements and enable migration of the one or more registered UE to the one or more layers of CSG cells.

In an embodiment, the method includes the step of enabling, by the system, the one or more UE to perform one or more actions, such as a normal call, based on validating one or more factors comprising an occurrence of at least one dangerous incident. The method includes the step of detecting, by the system, the identity of the at least one CSG cell impacted by the dangerous incident, and converting the at least one detected CSG cells to an open access cells and enabling access to the one or more UE. The occurrence of any dangerous incident is detected using an operations and support unit coupled to an external server may include at least one dangerous incident received from one or more sources comprising one or more sensors, a natural disaster monitoring system, a call centre. The one or more sensors may be coupled to at least one of a human body, a terrestrial geographical location, a non-terrestrial object. The natural disaster monitoring system may include a weather station and a seism monitoring center. The call centre may include any call coming from a subscriber who is reporting the occurrence of an accident. The conversion of the at least one detected CSG cells to the open access cell is either executed for the all unregistered UEs being served by the detected CSG cells or for the one or more unregistered UEs selected based on the SIM and a terrestrial geographical location. The detected CSG cell is reverted back from the open access to a CSG cell immediately after the dangerous incident is ceased or after a timer has expired and where the value of the timer is calculated based on a predefined value configured by the wireless network operator or based on an artificial intelligence technique to set dynamically the value of that timer based on previous experience with such dangerous incident event.

In an embodiment, the method includes the step of converting, by the system, the one or more CSG cell to an open access cell based on detecting a particular UE associated with at least one of a specific SIM card and a particular location after the occurrence of an equipment failure. The equipment may include a radio base station, an internet protocol router, a switch, a router and a transmission device. Further, inside the equipment is implemented a UE that has an access to a terrestrial wireless network and to a non-terrestrial mobile wireless network. Further, the method includes the step of reverting, by the system, the one or more CSG cell from an open access to CSG cell immediately after the equipment failure is recovered or after a timer has expired and where the value of the timer is calculated based on a predefined value configured by the wireless network operator or based on an artificial intelligence technique to set dynamically the value of the timer based on previous experience based on the equipment failure event.

In an embodiment, the method includes the step of converting the access to a terrestrial wireless network and to a non-terrestrial mobile wireless network could be direct that is from the UE to the base station over the air interface and indirect that is from the UE to the base station via a second UE that is used as a relay. The connection of the equipment with the terrestrial wireless network comprises an incorporated UE, a fiber optical cable, a coaxial cable, an Ethernet cable, and a microwave device. The connection of the equipment with the non-terrestrial wireless network comprises an incorporated UE and an antenna for a satellite.

Various objects, features, aspects and advantages of the inventive subject matter will become more apparent from the following detailed description of preferred embodiments, along with the accompanying drawing figures in which like numerals represent like components.

### BRIEF DESCRIPTION OF DRAWINGS

The accompanying drawings, which are incorporated herein, and constitute a part of this invention, illustrate exemplary embodiments of the disclosed methods and systems in which like reference numerals refer to the same parts throughout the different drawings. Components in the drawings are not necessarily to scale, emphasis instead being placed upon clearly illustrating the principles of the present invention. Some drawings may indicate the components using block diagrams and may not represent the internal circuitry of each component. It will be appreciated by those skilled in the art that invention of such drawings includes the invention of electrical components, electronic components or circuitry commonly used to implement such components.

FIG. 1 illustrates an exemplary network architecture in which or with which proposed system of the present disclosure can be implemented, in accordance with an embodiment of the present disclosure.

FIG. 2 illustrates an exemplary representation of the proposed system for enabling migration of a UE to a CSG layer, in accordance with an embodiment of the present disclosure.

FIG. 3 illustrates an exemplary block diagram representation of a UE for migrating a UE to a CSG layer, in accordance with an embodiment of the present disclosure.

FIG. 4 illustrates an exemplary flow diagram of a method for enabling migration of a UE to a CSG layer, in accordance with an embodiment of the present disclosure.

FIG. 5 illustrates an exemplary representation of a flow diagram of a method for converting the CSG cell into an open cell at the occurrence of dangerous incident, in accordance with an embodiment of the present disclosure.

FIG. 6 illustrates an exemplary representation of a flow diagram of a method for converting a CSG cell to open access cell only for some particular UEs after the occurrence of an equipment failure, in accordance with an embodiment of the present disclosure.

The foregoing shall be more apparent from the following more detailed description of the invention.

### DETAILED DESCRIPTION OF INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth.

The present disclosure provides five implementation techniques which includes, a first implementation technique pertains to a system and a method for communicating, on the public cell, information about the frequency used by the layer of CSG cells only to the UEs which are registered to that layer of CSG cells while avoid communicating such information to the other UEs. A second implementation technique includes, when a CSG cell belonging to one layer of CSG cells becomes unavailable the communication of the frequency used by the one or more layer of CSG cells may be avoided however it will be resumed when the one or more layer of CSG cells are available. A third implementation technique includes, the UE technique may be used to move between the one or more layer of CSG cells. A fourth implementation technique includes, at the occurrence of any accident that might impact the subscribers' life the one or more layer of CSG cells which covers the area of the accident will be temporary converted to an open access cells. A fifth implementation technique includes, the scenario after an equipment failure of the one or more layer of CSG cells is converted to open access cell only for particular UEs.

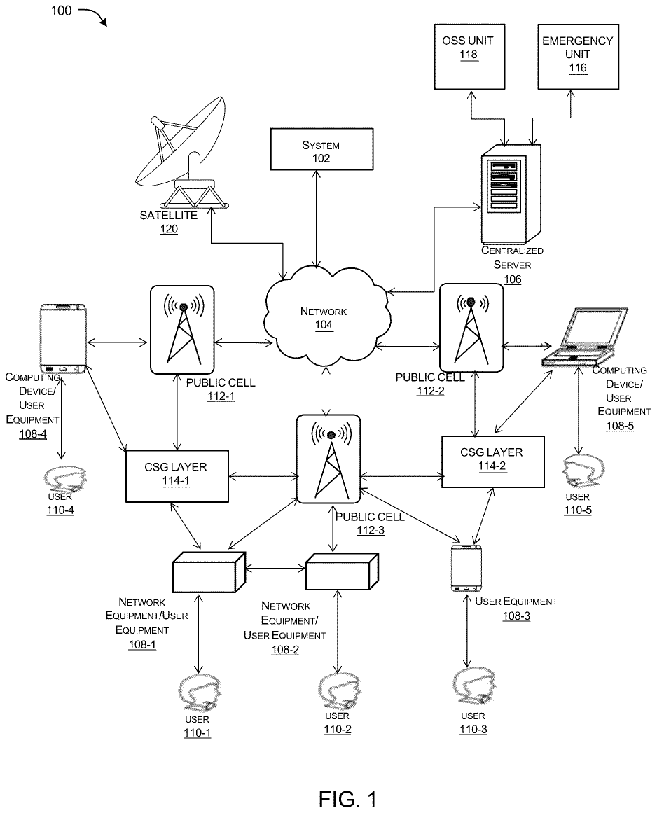

FIG. 1 illustrates an exemplary network architecture 100 in which or with which proposed system 102 of the present disclosure can be implemented, in accordance with an embodiment of the present disclosure.

Referring to FIG. 1 that illustrates an exemplary representation of telecom deployment architecture 100 may include the proposed system 102 with which or in which for enabling migration of a UE to a CSG layer, in accordance with various aspects of the disclosure.

In an embodiment, but not a limitation, the telecom deployment architecture 100 may include the system 102, a network 104, a centralized server 106, one or more computing devices/network equipment/UEs 108-1, 108-2 . . . 108-N associated with one or more users 110-1, 110-2 . . . 110-N, at least one public cell (112) 112-1, 112-2, . . . , 112-N, one or more layer of CSG cells 114-1, 114-2, . . . 114-N, an emergency unit 116, and an Operations and Support System (OSS) unit 118. A person of ordinary skill in the art will appreciate that the one or more User Equipment's (UEs) 108-1, 108-2 . . . 108-N may be collectively referred as one or more UE's 108 and individually referred as the UE 108. Similarly, the one or more users 110-1, 110-2 . . . 110-N may be collectively referred as users 110 and individually referred as the user 110. Furthermore, at least one public cell 112-1, 112-2, . . . , 112-N may be collectively referred as the at least one public cell 112 and individually referred as the public cell 112. Further, one or more layer of CSG cells 114-1, 114-2, . . . 114-N may be collectively referred as one or more layer of CSG cells 114 and individually referred as the layer of CSG cell 114. It may be appreciated that the terms “computing device”, “network equipment” and “(UE)” may be used interchangeably throughout the disclosure.

In an embodiment, the user 110 may include, but not be limited to, a network administrator, a network equipment, and others. Alternatively, or additionally, the user 110 may include one or more subscribers. The one or more subscribers relate to people who can receive and access the services of a particular network.

In an embodiment, the UE 108 may include, but not limited to, a handheld wireless communication device (e.g., a mobile phone, a smart phone, a phablet device, and so on), a wearable computer device (e.g., a head-mounted display computer device, a head-mounted camera device, a wristwatch computer device, and so on), a Global Positioning System (GPS) device, a laptop computer, a tablet computer, or another type of portable computer, a media playing device, a portable gaming system, and/or any other type of computer device with wireless communication capabilities, and the like. In an embodiment, the computing devices 108 may communicate with the system 102 via set of executable instructions residing on any operating system. In an embodiment, the computing devices 108 may include, but are not limited to, any electrical, electronic, electro-mechanical or an equipment or a combination of one or more of the above devices such as virtual reality (VR) devices, augmented reality (AR) devices, laptop, a general-purpose computer, desktop, personal digital assistant, tablet computer, mainframe computer, or any other computing device, wherein the computing device may include one or more in-built or externally coupled accessories including, but not limited to, a visual aid device such as camera, audio aid, a microphone, a keyboard, input devices for receiving input from a user 110 such as touch pad, touch enabled screen, electronic pen and the like. It may be appreciated that the UE 108 may not be restricted to the mentioned devices and various other devices may be used.

In an embodiment, the proposed system 102 may include one or more layer of CSG cells 114 coupled to the at least one public cell 112. The one or more layer of CSG cells 114 may be configured to provide a plurality of services to the UE 108 within one or more layer of CSG cells 114. The one or more UE 108 may be communicatively coupled to the at least one public cell 112 and the one or more layer of CSG cells 114. The one or more UE 108 may be configured to utilize one or more network resources and access the plurality of services to perform one or more operations. The one or more UE 108 may include at least one of the one or more registered UE and the one or more unregistered UE 108.

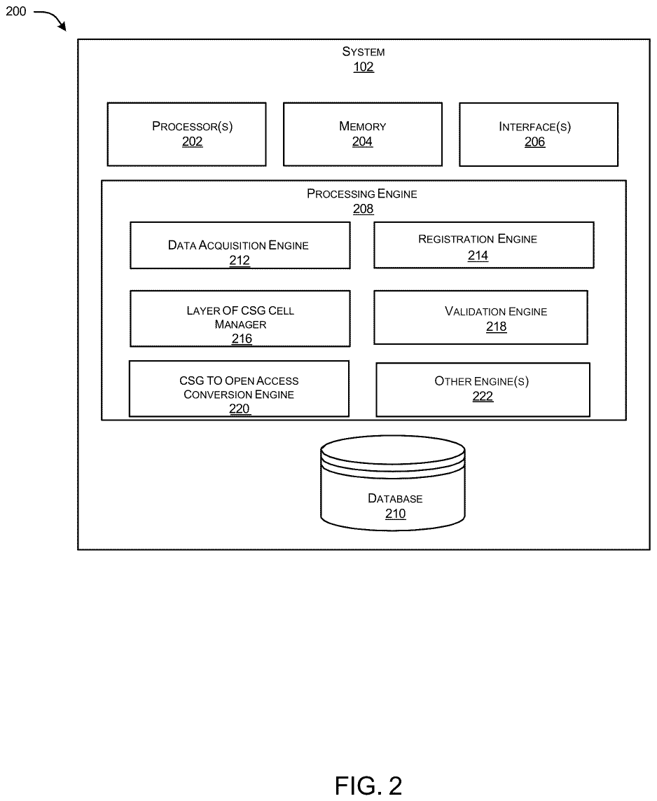

In an embodiment, the proposed system 102 may be equipped with one or more processor 202 (shown in FIG. 2) that may cause the system 102 to manage migration of the one or more registered UE 108 from the at least one public cell 112 to the one or more layer of CSG cells 114. The migration of the one or more registered UE 108 is based on communicating information of a pre-defined frequency which may broadcast the information of the pre-defined frequency via the at least one public cell 112 to the one or more UE 108 based on one or more conditions. The one or more registered UE 108 may be configured to validate the one or more conditions, and the one or more unregistered UE 108 may be configured to overlook the information. The system 102 may store the information of the pre-defined frequency of the one or more layer of CSG cells 114 on the SIM card of the one or more registered UE 108.

In an embodiment, the system 102 may transmit the information of the pre-defined frequency to the one or more registered UE 108 by using a dedicated signalling message triggered by the at least one public cell 112 by a fall back procedure. The system 102 may transmit via the at least one public cell 112 to the one or more registered UE 108 the type of a RAT that is running on the layer of CSG cells 114, and the one or more registered UE 108 may be configured to scan one or more frequencies associated with the RAT. The system 102 may receive the communicated pre-defined frequency information by the one or more registered UE to perform one or more radio measurements and enable migration of the one or more registered UE 108 to the one or more layer of CSG cells 114.

In an embodiment, the one or more layer of CSG cells comprise one or more micro-CSG cells positioned adjacent to each other to provide a wide range of radio coverage to the one or more registered UE 108. The pre-defined frequency comprises a value of frequency used by each of the one or more micro-CSG cells belonging to the one or more layer of CSG cells and the priority of the pre-defined frequency. The one or more UE is configured to registered to a multiple number of the one or more layer of CSG cells, and detect the identity of each layer based on the information stored on the SIM card.

In an embodiment, the scenario, where not all UEs 108 being served by a public cell 112 are registered to a CSG cell, is introduced. In other words, on the same public cell 112, some UEs 108 could move to a CSG cell, overlapping the public cell 112, and perform a call on it whereas other UEs 108 are prevented from moving to that CSG cell as they are not registered to it and hence they could not perform a call on it. To avoid radio interference and to make it easier the prevention of a UE 108 on a public cell to move to a CSG cell, the CSG cell will be running on a frequency that is different from the one running on the public cell 112.

Considering that, actually on each serving cell of a mobile wireless network a list of all the other frequencies, called inter-frequencies, that are used by other cells in the network are broadcasted by the cell to the UE. For instance, in a 5G network which is used as an example of implementation in the present disclosure, the information related to each frequency of that list of inter-frequency is communicated by the cell to the UEs via an IE (Information Element) called InterFreqCarrierFreqInfo which is defined in the standards specification 38.331 and that is broadcasted via SIB4 (System Information Block 4). Based on specification 38.331, v16.6.0, InterFreqCarrierFreqInfo contains many parameters such as dl-CarrierFreq, frequencyBandList, smtc, q-RxLevMin, q-QualMin, p-Max, t-ReselectionNR, threshX-HighP, threshX-LowP and cellReselectionPriority.

Further, the system 102 focus mainly on two parameters which are the dl-CarrierFreq that represents the value of the inter-frequency and the cellReselectionPriority that represents the priority of that inter-frequency and which takes any value from 0 to 7 where the value 0 is the lowest priority. For instance, for the UE 108 to move from one cell running on a first frequency to another cell running on a second frequency, one of the following two executions are used in some procedures described below. In a first execution, the UE 108 uses all the parameters of InterFreqCarrierFreqInfo as defined in the standards whereas in a second execution only the two parameters of InterFreqCarrierFreqInfo that are dl-CarrierFreq and cellReselectionPriority are used.

In an embodiment, the UE 108 may be registered to the one or more layers of CSG cells 114 where each layer is running on a different frequency. Suppose that two layers of CSG cells, a first one providing wifi and the second one providing 6G are running respectively on frequencies (dl-CarrierFreq) freq1 and freq3 which have respectively frequency priorities (cellReselectionPriority) 6 and 7. Suppose that these two layers of CSG cell 114 are overlapping a public cell 112 running on freq2 and having any lower frequency priority, e.g. 5. In such example the broadcast of the instances of the standards InterFreqCarrierFreqInfo on each of these three cells could be illustrated as follows: The public cell 112 will broadcast two instances of InterFreqCarrierFreqInfo as follows: A first instance contains freq1 and its priority 6 representing the first layer of CSG cells. A second instance contains freq3 and its priority 7 representing the second layer of CSG cells. Whereas, each cell belonging to the first layer of CSG cells will broadcast two instances of InterFreqCarrierFreqInfo as follows: A first instance contains freq2 and its priority 5 representing the public cell 112. A second instance contains freq3 and its priority 7 representing the second layer of CSG cells. Lastly, each cell belonging to the second layer of CSG cells will broadcast two instances of InterFreqCarrierFreqInfo as follows: A first instance contains freq2 and its priority 5 representing the public cell 112. A second instance contains freq1 and its priority 6 representing the first layer of CSG cells.

Further, by following actual standards solution where each cell broadcast one InterFreqCarrierFreqInfo instance per one inter-frequency, in the scenario where not all the UEs being served by a public cell 112 are registered to CSG cell an existing problem might be illustrated with the following example: Suppose that two UEs, UE1 and UE2, are being served by the public cell 112 but UE1 is registered to the two layers of CSG cells running on freq1 and freq3 in our example above whereas UE2 is not registered to any of these two CSG cells. If the existing standards is followed, the public cell 112 will be broadcasting, equally, to all the UEs being served by it, the two instances of InterFreqCarrierFreqInfo that include respectively freq1 and freq3. Or when UE1 receives freq1 and freq2 this is useful information as it allows UE1 to move to the two layers of the CSG cells. However, when UE2 108 receives freq1 and freq3 then this will create a problem because UE2 108 will be using these two frequencies to search for a suitable cell on them and as they are running on CSG cells to which UE2 is not registered then all these searches not only will be useless but also they are a waste of processing and of battery consumption. To overcome the said problem, the first implementation technique, is proposed and it might be executed via one of four different procedures or via a combination of all these four procedures. In each of these four procedures described below, a different method is used to communicate to the UEs that are registered to a layer of CSG cells, either via the public cell 112 or via UE SIM card, an information about the frequencies used by that layer of the CSG cells.

According to the first procedure of the first implementation technique the system 102 may be configured to broadcast the information of the one or more layer of CSG cells by using the at least one public cell 112 based on a count of the one or more layer of CSG cells available, the identity of each layer of one or more micro-CSG cells and information related to the pre-defined frequency associated with the one or more layer of CSG cells. Further, the priority of the pre-defined frequency of the one or more layer of CSG cells is higher than the priority of the pre-defined frequency of the at least one public cell 112. The one or more registered UE is configured to access content of the broadcasted information to migrate from the at least one public cell 112 to the one or more CSG layer of CSG cells, wherein the one or more unregistered UE is configured to overlook the content of the new broadcasted information.

At the initial state of the first procedure, the UE 108 is served by a public cell 112 that is overlapped by a CSG that is part of a layer of CSG cells. Not all the UEs being served on the public cell 112 are registered to a layer of CSG cells. The priority of the frequency of any layer of CSG cells is higher than the priority of the frequency used by any public cell 112. This is done on one hand to facilitate the move of a UE being served by a public cell 112 and on the other hand to favor the UE stay on a layer of CSG cells over its stay on a public cell 112. Each UE that is registered to a layer of CSG cells will be having on its SIM card an identity of the layer of CSG cells to which it is registered. In one example if the UE is registered to two layers of CSG cells, e.g. 6G and wifi, these layers might be deposited on the UE SIM card with special identities such as layer1 (for 6G) and layer2 (for wifi). This is done because two layers of CSG cell might belong to the same RAT, e.g. to 6G.

The system 102 is then configured to create two new parameters on the public cell 112. On the public cell 112, two new parameters are added to the cell broadcasted system information, e.g. to SIB4 as follows: A first parameter denoted as number_of_layers_CSG_cells and it informs the UE about the number of existing layers of CSG cells. A second parameter denoted as FreqInfo_for_layers_of_CSGcell has the role to communicate to the UE, information about the frequency of the layers of CSG cells.

For each layer of CSG cells 114, this second parameter might be in turn composed of two info as follows: (info 1) indicates the identity of each available layer of CSG cells. (info 2) is about an instance of information about the frequency of the layers of CSG cells. This (info 2) could come in one of the following two formats: (info 2, format 1) consists of using one instance of the existing InterFreqCarrierFreqInfo which contains many parameters as described above. (info 2, format 2) comprises only two values. A first one, dl-CarrierFreq, represents the value of the frequency used by a layer of CSG cells and a second one, cellReselectionPriority, is the value of the priority of that frequency. The difference between (info 2, format 1) and (info 2, format 2) is that for (info 2, format 2) much less information is used than in case of (info 2, format 1) and hence much less number of bits are broadcasted over the air interface. However, (info 2, format 2) contains additional parameters that make the move of the UE more efficient than one using (info 2, format 1).

When the UE receives the two new parameters related to the layers of CSG cells it will behave as follows: For a UE 108 that is not registered to any layer of CSG cells, it ignores the above two new parameters. For a UE that is registered to at least one layer of CSG cell, e.g. layer1, it reads the values of the two new parameters. By having the value of the frequency of layer1 and its priority, the UE could move from the public cell 112 to layer1 of CSG cells by using existing standard methods especially that, as mentioned in the initial state, the priority of the frequency of any layer of CSG cells is higher than the priority of the frequency that is running on the public cell 112. Note that here and in the rest of the disclosure, the move of a UE 108 from a public cell 112 to a layer of CSG cells 114 means the move of a UE from a public cell 112 to a CSG cell that belongs to a layer of CSG cells.

According to the second procedure of the first implementation technique, the system is configured to broadcast the information by using the at least one public cell 112 based on the priority of the pre-defined frequency of the one or more layer of CSG cells 114 is higher than the priority of the pre-defined frequency of the at least one public cell 112. Further, the system 102 may store the information of the pre-defined frequency used by each of the one or more layer of CSG cells on the SIM card of the one or more registered UE registered. The one or more registered UE registered is configured to collect a pre-defined frequency information pertaining to a target CSG layer, and store the pre-defined frequency information in a UE database during a first time access and perform one or more radio measurements and enable migration of the one or more registered UE to the one or more layer of CSG cell.

The initial state of the second procedure includes the UE 108 is served by a public cell 112 that is overlapped by a CSG that is part of a layer of CSG cells. Not all the UEs 108 being served on the public cell 112 are registered to a layer of CSG cells. The priority of the frequency of any layer of CSG cells is higher than the priority of the frequency used by any public cell 112. This is done on one hand to facilitate the move of a UE 108 being served by a public cell 112 and on the other hand to favor the UE 108 stay on a layer of CSG cells over its stay on a public cell 112.

The system 102 is configured to store information about a layer of CSG cells on the SIM card of the UE. The information related to a layer of CSG cells is deposited on the SIM cad of the UE 108 and they consist only of information related to the frequency used by each layer of CSG cell to which the UE 108 is registered to. Such information could take one of the following two formats: The first format, denoted as UE_SIM_stored_CSG_frequency_and_its_priorirty_layer, comprises two information that are the frequency on which the layer of CSG cells is running and the priority of that frequency. The second format, denoted as UE_SIM_stored_InterFreqCarrierFreqInfo_layer, comprises all the parameters of InterFreqCarrierFreqInfo as defined in the standards. The value of the parameters of InterFreqCarrierFreqInfo might change from one cell to another one depending on many factors such as the geographical location of the cell, the frequency being used, the number of surrounding cells, the number of subscribers covered in the area etc. In other words, these parameters are not the same for every cell in the network and storing the same template of UE_SIM_stored_InterFreqCarrierFreqInfo on the SIM cards of all the registered UEs might not be an efficient solution however as the intention is to make the UE move from a public cell 112 to the CSG cell then such single template for all registered UEs might be justified.

The UE 108 that is not registered to a layer of CSG cell 114, none of the above two formats of CSG information is deposited on the SIM card of that UE. As a consequence, such UE 108 will not consult its SIM card to get any information related to a layer of the CSG cells 114. Whereas for a UE 108 that is registered to a layer of CSG cells 114 its behaviour will be as follows: When a UE 108 that is registered to a layer of CSG cells 114 wants to access a layer of CSG 114 cells from a public cell 112, then for the first access it will copy the information related to that layer from the UE SIM card into a database at the UE side, denoted database_two_formats_CSG_cell. Further, for any following access of the UE to that layer of CSG cells, UE does not need to read CSG cell information from the SIM card rather it could collect them from database_two_formats_CSG_cell. In other words, when the UE 108 wants to move from a public cell 112 to a layer of CSG cells it will collect frequency information from the UE SIM card only for the first access. For the following access the UE could collect frequency information from database_two_formats_CSG_cell.

After collecting the CSG cell information either from the SIM card or from database_two_formats_CSG_cell, to move from a public cell 112 to a layer of CSG cells the UE will perform one of the following two procedures depending on which format is being used: If UE_SIM_stored_InterFreqCarrierFreqInfo format is used, the UE 108 takes into consideration all the other parameters defined in InterFreqCarrierFreqInfo. If UE_SIM_stored_CSG_frequency_and_its_priorirty format is used, then only two information, the frequency of the CSG cell and its priority, are used. In both cases, the UE 108 move from the public cell 112 to a layer of CSG cell follows existing standards procedures that are used by a UE to move between two public cell 112. Moreover, in the case of a move from a public cell 112 to a layer of CSG cells as it is in our example, such move is facilitated by the fact that the frequency priority on target layer of CSG cells has a higher frequency priority than on the source public cell 112. Further, the move of a UE 108 from a public cell 112 towards CSG cell 114 is more efficient when the first format, UE_SIM_stored_InterFreqCarrierFreqInfo, is used than in case the second format, UE_SIM_stored_CSG_frequency_and_its_priorirty, is used, because the first format contains more parameters than the first format and which are used in order to make the move between two cell more efficient or say more optimized. However, the advantage of the second format over the first format is that less information, say less bits, and are stored on the SIM card of the UE 108.

According to the third procedure of the first implementation technique, the system 102 is configured to enable another embodiment based on the information about the frequency of the layer of CSG cells 114 is not communicated to the UEs in any way. In other words, it is not communicated to the UE 108 via the broadcasted public cell 112 system information nor it is conveyed to the UE 108 via some stored information on its SIM card.

The initial step of the third procedure includes the UE 108 that is registered to a layer of CSG cells 114 has the identity of that layer stored at the UE SIM card. Two new parameters are broadcasted over the air interface of the public cell 112. A first parameter denoted as number_of_layers_CSG_cells and it informs the UE 108 about the number of existing layers of CSG cells. A second parameter denoted as identities_of_layers_of_CSG_cells and which contains only one information, (info 1), which indicates the identity of each available layer of CSG cells. The RAT and the frequency of each layer of CSG cells are configured in the database of the public cell 112. Based on existing standards, each time a UE 108 establishes a call setup, an establishment cause is mentioned by the UE to the cell in a signaling message. In a 5G network that establishment cause is transmitted by the UE to the cell via RRC message, RRCSetupRequest. Based on the latest RRC protocol specification 38.331, the available options of establishment cause are listed in the below text extracted from 38.331, v16.16.0.

EstablishmentCause::=ENUMERATED{emergency, highPriorityAccess, mt-Access, mo-signalling, mo-Data, mo-VoiceCall, mo-VideoCall, mo-SMS, mps-PriorityAccess, mcs-PriorityAccess, spare6, spare5, spare4, spare3, spare2, spare1}.

A new establishment cause has to be added to the existing ones. In one example, a new call establishment cause, e.g. denoted ‘access a layer of CSG cells’, might be used instead of spare1. A fallback procedure, similar to the existing CS fallback procedure on a LTE network, is allowed on the network of the public cell 112. This new procedure consists of the following: Each time a UE being served by a public cell 112 wants to access the service provided by a CSG cell belonging to one layer, e.g. layer1, it will include in its call request the new establishment cause ‘access a layer of CSG cells’. After receiving the new establishment cause, the network of the public cell 112, either the radio access network or the Core network, will command the UE to move from the public cell 112 to layer1 of CSG cells by providing that UE the frequency and the RAT used by layer1. To favor the UE stay on the public cell 112, the priority of the frequency of the public cell 112 is higher than the priority of the frequency on any layer of CSG cells.

The UE that is not registered to a layer of CSG cells that is being broadcasted in identities_of_layers_of_CSG_cells will ignore the above two broadcasted parameters, number_of_layers_CSG_cells and identities_of_layers_of_CSG_cells, and the above mentioned fallback procedure will not apply on it. Whereas, for the UE that is registered to a layer of CSG cells that is being broadcasted in identities_of_layers_of_CSG_cells, the following action is executed: The UE triggers on the public cell 112 a new call setup with establishment cause equal to ‘access a layer of CSG cells’ where based on the information that is already store on its SIM card, it will indicate to the radio access network, that is to the cell, and optionally to the Core network, that is to the AMF in a 5G network, the identity of the layer of CSG cells to which the UE wants to access.

A command which may be triggered by the core network or by the radio access network enables a direct retry procedure is executed as follows: the cell will transmit to the UE 108 via a dedicated signaling message, e.g. via existing RRCRelease message, the frequency and the RAT of the requested layer of CSG cell. Once the UE 108 is directed to a CSG cell on that registered layer of CSG cells, it will complete its call setup there and benefit from the service until it releases its call. Once the call is released on the CSG cell, based on one of the initial state of the third procedure as the priority of the frequency of the public cell 112 is higher than the priority of the frequency on any layer of CSG cells, when the call is released on the CSG cell, the UE is most likely to return to the public cell 112. Once the UE is on the public cell 112, at any time later it wants to access a layer of CSG cells, the above actions will be executed again.

With the previous three procedures, described above, the information about the frequency used by a layer of CSG cells is communicated to the UE by the public cell 112 or via UE SIM card. Whereas with the following fourth procedure no information that is related to the frequency used by a layer of CSG cell is communicated to the UE.

In an embodiment, the system 102 maybe configured to enable migration of the one or more registered UE 108 from a first CSG layer to a second CSG layer based on the priority of the pre-defined frequency set by the one or more registered UE 108. The priority of the pre-defined frequency of the second CSG layer is set higher than the priority of the frequency used on the first CSG layer.

According to the fourth procedure of the first implementation technique. The initial state of the fourth procedure includes the UE 108 is served by a public cell 112 that is overlapped by a CSG cell that is part of a layer of CSG cells. Not all the UEs being served on the public cell 112 are registered to a layer of CSG cells. Each UE that is registered to a layer of CSG cells will be having on its SIM card an identity of the layer of CSG cells to which it is registered. The frequency priority used on any layer of CSG cells is higher than frequency priority used on any public cell 112.

Two new parameters are broadcasted over the air interface of the public cell 112 as follows: a first parameter denoted as number_of_layers_CSG_cells and it informs the UE about the number of existing layers of CSG cells. A second parameter denoted as identities_of_layers_of_CSG_cells and which contains only one information, (Info 1), which indicates the identity of each available layer of CSG cells. In addition, a third parameter that represent the RAT of each layer is communicated to the UE via one of the following two ways: Either it is added as (info 2) to the second parameter identities_of_layers_of_CSG_cells and hence it is broadcasted by the public cell 112 over the air interface. Or it could be stored on the SIM card of a UE that is registered to a layer of CSG cells.

When the UE 108 receives the new broadcasted parameters it will behave as follows: A UE that is not registered to any broadcasted layer of CSG cells will ignore the contents of the above new defined three parameters. The UE 108 that is registered to any broadcasted layer of CSG cells will take into consideration the contents of the above new defined three parameters and it will act as follows: By reading the contents of the third parameter, the UE 108 will have knowledge about the RAT of each layer it is registered to, it will scan all frequencies related to that RAT to search for an available CSG cell to which it is registered. Once it camps on a CSG cell of any layer for the first time, it will read its broadcasted system information and stores in its memory all the information related to the frequency of the serving layer of CSG cells 114. As mentioned in the initial state, the frequency priority of any layer of CSG cells 114 is higher than the frequency priority of any public cell 112. Hence, after the UE 108 has moved from the public cell 112 to the layer of CSG cells, it should not come back to public cell 112 unless the radio conditions of that UE on the CSG cell becomes deteriorated. After that first time access to a CSG cell on a layer, as the UE 108 has already stored all the frequency required information, then if the UE moves back to a public cell 112, it does not have to scan again all the frequencies of the RAT running on the serving layer of CSG cells.

In a second implementation technique when a CSG cell, for instance, the CSG_cell 1 belonging to one or more layer of CSG cells 114, e.g. layer1 114-1, is overlapping a public cell, e.g. public_cell 2 112-1, the objective is to inform the UEs 108 being served by the public cell 2 112-1 when layer1 114-1 becomes unavailable and later inform them when layer1 114-1 becomes available again. For that purpose, a new software entity, e.g. denoted as remove&re-add_frequency_of_CSG_cell_from_a_public_cell, is implemented at the OSS 118 where on one hand it could detect the generation of an OSS alarm each time a cell, including CSG cells, becomes faulty and on the other hand it could detect the clearance of that alarm when the faulty cell is recovered. Being implemented at the OSS 118, that new software entity could also know whether one CSG cell is overlapping a public cell, whether two or more CSG cells are overlapping the public cell or whether no CSG cell is covering the public cell.

The behaviour of the second implementation technique depends on which of the following two scenarios is used. In a first scenario the two parameters described above, number_of_layers_CSG_cells and identities_of_layers_of_CSG_cell, which respectively represent the number and the identity of every available layer of CSG, are broadcasted via the public cell to the UEs. In a second scenario, neither the number of available layers of CSG cells nor their identities are broadcasted over the air interface to the UEs.

When the first scenario is used, if at a time, e.g. t1, CSG_cell1 becomes unavailable, then remove&re-add_frequency_of_CSG_cell_from_a_public_cell will set on public_cell 2 112-1 the two parameters, number_of_layers_CSG_cells and identities_of_layers_of_CSGcell, as follows: The value of number_of_layers_CSG_cells will be decreased by 1, and layer 1 will be removed from the list of layers included in identities_of_layers_of_CSGcell. Later at a time t2, when the fault on the overlapping CSG_cell1 is recovered, then remove&re-add_frequency_of_CSG_cell_from_a_public_cell will set the two parameters, number_of_layers_CSG_cells and identities_of_layers_of_CSGcell, as follows: The value of number_of_layers_CSG_cells will be increased by 1, and layer1 will be added to the list of layers included in identities_of_layers_of_CSGcell.

When the second scenario is used, the number of available layers of CSG cells and their identities are not broadcasted over the air interface. As a result, the UE 108 may never know beforehand whether a layer of CSG cells 114 to which it is registered is available or not at the time it is requesting a call to access that layer. In such scenario, one of the following two examples of solutions might be used. In a first example of solutions, when a UE 108 being served by a first public cell, e.g. public_cell 2, request a service to access one layer of CSG cells that is not available at the time of that request, e.g. layer1 in our example, the public cell will reject that request via a signaling message, e.g. via RRCRelease message, and inside that message a timer is provided to the UE so that only after that timer expiry the UE 108 could request again a call request to access that layer of CSG cells.

In a second example of solutions, an artificial intelligence technique implemented at the UE 108 may inform the UE 108 whenever the overlapping CSG cell is not available and the UE might try at different configured intervals to search for the availability of the CSG cell.

In an embodiment, the advantage of removing and re-adding a layer of CSG cells on a public cell is to prevent a UE 108 being served on a public cell from searching uselessly, on the frequency used by a layer of CSG cells, for a CSG cell overlapping the public cell and that is not available, e.g. due to a software or a hardware fault.

In a third implementation technique, the system 102 may be configured to allow the UE 108 to move from a first CSG layer to a second CSG layer by setting the priority of the frequency of the second layer as higher than the priority of the frequency of the first layer. During initial state of the third implementation technique the priority of the frequency of any layer of CSG cells is higher than the priority of the frequency of any public cell. This is done to favor the stay of a UE 108 on any layer of CSG cells over its stay on a public cell. Considering that, to make the UE move from any CSG cell towards a public cell due to UE radio degradations at the UE side on the CSG cell, existing handover solutions are used.

Following are two non-limited examples of when the UE 108 needs to move from a first layer of CSG cells 114 towards a second one. In a first example, suppose that a UE is registered to two layers of CSG cells where a first CSG layer is providing 6G and a second CSG layer is providing wifi. Suppose that it is cheaper for the UE to stay longer on the wifi layer than on the 6G layer, then even if 6G layer has a higher frequency priority than of the wifi layer the UE 108 still has to be allowed to move to the wifi layer. In a second example, one application may run on 6G but not on wifi, e.g. a hologram call. As a consequence, when the UE 108 being served by CSG wifi layer wants to run that application, it has to move from the wifi layer to a 6G CSG layer.

The actual problem is that if a UE 108 is experiencing very good radio conditions at a first layer of CSG cell, e.g. 6G, which is running on a first frequency that has the highest frequency priority, then to make the UE 108 move from that first layer to second layer, e.g. wifi, that it is running on a second frequency that has a lower frequency priority than of the frequency priority of the first layer, existing solutions do not work. In order to allow the UE 108 perform such move, the system 102 may consist of creating a new software entity, e.g. denoted as UE_entity_switch_between_layers, that is implemented at the UE side. Before describing the role of this new entity, it should be mentioned that actually each cell broadcast, periodically every few milliseconds, its system information to all UEs 108. In order not to read again and again the same repeated broadcasted information, when the UE reads for the first time the system information, including contents of SIB4 which include our main subject inter-frequency information, it will store the received system information in one memory location at the UE side, denoted in the present disclosure as table1. As a result, as long as the UE 108 is being served by that cell, it will not read again the values of the broadcasted system information until either a change of one of the stored parameters has been made or a certain period of time has expired.

The third implementation technique might be executed via one of the following two procedures. In a first procedure, the role of UE_entity_switch_between_layers is to create a new table, denoted here as table2, which contains only the inter-frequencies that belong to layers of CSG cells together with their priorities. Initially this table is filled by copying from table1 the values of the frequencies running on all the available layers of CSG cells and their priorities. Suppose that initially on table1 two layers of CSG are stored as follows: a first layer providing 6G is running on freq1 and has the highest frequency priority that is 7 and a second layer providing wifi is running on freq3 and has the second highest frequency priority 6. Later at any time a UE 108 being served by a first layer of CSG cell wants to use the service provided by a second layer of CSG cells, the main role of the new entity UE_entity_switch_between_layers is to set, on table2, the priority of the frequency of the second layer as being higher than the one of the first layer. As a result of such setting the UE 108 could move from the first layer to the second layer and hence benefit from the services of the second layer.

Different solutions might be used to trigger the change of layers via UE_entity_switch_between_layers. Following are three examples of such solutions. In a first example, a mobile application is provided by the network operator, e.g. it could be downloaded from the operator website. In such mobile application, an icon for each available CSG layer is available and not only the subscriber could select which CSG layer he wants to select at specific time but he could set a period of time during which he wants a specific layer to be running.

In a second example, to trigger the change of layers, a software icon is used, e.g. to make a hologram call, the subscriber should push a dedicated software hologram icon on his mobile phone and as in our example the hologram is only provided by the 6G layer then when the subscriber pushes the hologram icon the UE is moved to the 6G layer.

In a third example, to trigger the change of layers, an artificial intelligence technique is used, which monitors the subscriber activity on each layer, e.g. each day from 09:00 till 5 h:00 pm he is using wifi at work office, and from 05 h:30 pm till 08:00 pm he is using 6G and so on for the rest of the day. Then this artificial intelligence technique will set the highest frequency priority during each period of time according to the behaviour of the subscriber.

In a second procedure of the third implementation technique, a fallback procedure is used to move the UE from one layer of CSG cells towards another layer of CSG cells irrespective of the priority of the frequencies running on both layers. In one example, if a UE served by a 6G layer having the highest frequency priority, that is 7, request a call service to use wifi layer, having a lower frequency priority, e.g. equal to 6, then 6G cell will reject the call request of that UE by providing in the reject signalling message the frequency of the wifi layer so that the UE uses the received frequency to move to the wifi layer. But once the wifi call is released the UE will move back to the 6G layer as it has the highest frequency priority.

In a fourth implementation technique, the system 102 may be configured to convert a CSG cell into an open cell at the occurrence of a dangerous incident. In fact, actually, whatever is the type of a CSG cell, whether it is an isolated home base station covering a house or whether it belongs to a layer of CSG cells which covers a wide range of area, any UE held by a subscriber, e.g. subscriber 1, that is non-registered to a CSG cell, e.g. CSG_cell1, could perform only an emergency call, e.g. 112 or 911, on that CSG_cell1 which connects him to an authority department, usually to the closest police station. However, in many situations, especially when a dangerous incident occurs inside an area covered by CSG_cell1 at a time when all the public cells surrounding CSG_cell1, are either unavailable or congested, it would be much more beneficial for subscriber 1 to be able to perform normal calls on CSG_cell1, such a video call or calling directly a doctor or a relative etc. The fourth implementation technique might be composed of the following five steps.

In a first step, denoted as the initial state, a new software entity, e.g. denoted as the emergency_unit 116, is implemented at the OSS which incorporate the following roles: detecting the occurrence of a dangerous incident, detecting the presence of a CSG cell in the nearby of the dangerous incident, and converting the impacted CSG cell to an Open access cell.

In a second step, the emergency unit 116 may be connected to an external server, denoted as dangerous_incidents_server, which has the role of receiving notifications of all types of dangerous incidents that occur at any location of the network 104. In an exemplary embodiment, following are a non-limited five types of input for dangerous_incidents_server: A first type of input could be the triggering of any smart sensor that reflects the occurrence of a dangerous incident. Following are some examples of such sensor inputs: A biological sensor is attached to the body of a patient. A fire sensors located indoor or outdoor. An anti-theft sensor. A sensor that detects dangerous gas and so on. A sensor associated with a vehicle, or an image capturing unit that is monitoring a street, detects a car accident, and the like. The operator of the network 104 may select which sensors have to be added as an input to dangerous_incidents_server.

One could understand that the sensors listed in the first input above are implemented on the ground. However, as an example of the second type of input, some sensors might be mounted on a moving drone or on a satellite. Hence the dangerous_incidents_server might receive input from the control stations of the drones and the satellites that are equipped with sensors capable of detecting accidents.

A third type of input, consists of connecting dangerous_incidents_server to any center that detects dangerous incidents such as a weather monitoring center and a seism monitoring center. When any accident, e.g. a tornado or an earthquake etc . . . , is detected by any of these centers, a notification about that accident is then transmitted, in real time, to the dangerous_incidents_server.

A fourth type of input might come from a subscriber who calls any authority such as the police or a fire station or an ambulance etc . . . when he encounters an accident.

The fifth type of input consists of using early sensor alarm notification as follows: Actually the majority of the sensors report only one sensor alarm notification that is when the sensor reaches 100% of a predefined threshold. Considering that, some sensors, usually that detect any of the above dangerous incident, might be configured with a tool, that comprises a software entity or a hardware entity or a combination of both, to report early sensor alarm notifications to their configured destination which could be classified into two categories. A first destination category might be a configured phone number of an entity where the sensors notification is sent to such as a fire station (case of a fire alarm) or a doctor (case of a biological sensor). A second destination category might be the serving radio access of the mobile wireless network. In one example, such sensors might be configured with different sub-thresholds, such as 5%, 20%, 30% etc . . . and as a result before reaching the 100% threshold, these sensors could report an early sensor alarm notification whenever they reach any of the predefined sub-thresholds such as when a sensor reaches the sub-threshold of 5%. In another example, an artificial intelligence and machine learning techniques might be implemented in such sensors and could predict at any time, e.g. a time t1, that a future time, e.g. at time t2, a sensor alarm might be triggered and as a consequence they could report an early sensor alarm notification that is at time t1.

Further, the objective of the early sensor alarm notification is to make the two categories of target destinations, the preconfigured destination such a doctor and the radio access network, take an early action. In this disclosure an early action might consist of triggering the conversion of a CSG cell at the receipt of an early sensor notification alarm. In one example, suppose that one of such sensors, e.g. a dangerous sensor denoted as sensor1, is registered to a terrestrial first mobile wireless operator, e.g. operator 1, but it is not registered to a terrestrial, or non-terrestrial, second mobile wireless operator, e.g. operator 2. As a result, cells of operator 1 could behave as public cells for sensor1 whereas cells of operator 2 could behave as CSG cells for sensor1 as it could not perform normal calls on the cells of operator 2. Suppose that for sensor 1, the time to go from 5% Threshold to 100% threshold requires 3 minutes. As a consequence, when sensor1 has reached 5%, e.g. at 11 h 59 pm, an early notification is sent to operator 1 and a conversion of cells of operator 2 covering sensor1 from CSG cell to open access cell is executed at time t1. As a result, if by chance at any time after 11 h 59 pm the cells of operator 1 covering sensor1 area go down, sensor1 will still be able to communicate with its target destinations via cells of operator 2 as they have already been converted from CSG cell to open access cell.

Irrespective of the input type, the location of the dangerous incident may be estimated, along with the proximity range of the impacted area. Further, the impacted area depends on the type and of the location of the sensor. In a first example, if a biological sensor is triggered, its impact is on that patient only. In a second example, if a fire sensor is triggered in a flat then its range is a few meters whereas if the same type of sensor is triggered in a forest then its impacted area is much bigger. In a third example, if the input is coming from a weather monitoring system, a notification about the type of the incident, e.g. hurricane, and its impacted area could be a part or a whole city. At the end, each time a notification about a dangerous incident is triggered, its location X and the impacted area are reported to dangerous_incidents_server which will systematically forward the received information to the emergency_unit 116.

In a third step of the fourth implementation technique, once the emergency_unit 116 receives a notification from an external dangerous_incidents_server with the location X and the range of impacted area, its main role at this stage is to detect all the potential cells, public and CSG, that could be impacted by the dangerous incident. In one embodiment, the emergency_unit 116 is implemented at the OSS and hence it has access to all the configured geographical locations of all cells in the network. Furthermore, it could then detect all the public and CSG cells that are located in the incident impacted area.

In a fourth step of the fourth implementation technique, the emergency_unit 116 may convert a detected CSG cell into an open access cell into one of the following two ways: In a first way, every CSG cell located in the incident impacted area, is converted systematically into an open access cell. In a second way, every CSG cell located in the incident impacted area, is converted into an open access cell only when certain conditions are met. Such conditions might be configured by the operator of the mobile wireless network. In one example of conditions, convert a CSG cell located in the incident impacted area only when its surrounding public cells are either unavailable or congested.

Further, the conversion of a CSG cell to an open access cell could be performed either for all UEs under the CSG cell or only for some particular UEs. In one example, these particular UEs could be the ones located within an area of a building impacted by a dangerous incident. In another example, they comprise UEs with some particular SIM cards such as the SIM card of a sensor that is configured to report early alarm notification.

In a fifth step of the fourth implementation technique, the system 102 may be configured to revert back a CSG cell from an open access cell to initial CSG cell. In fact, after a CSG cell, e.g. CSG_cell1, is converted from a CG cell to an open access cell, e.g. due to a dangerous incident such as a gas leakage in one area, that temporary open access on CSG_cell1 will be stopped and CSG_cell1 will be reverted back to a CSG cell status either immediately after the dangerous incident is ceased or after a timer has expired. The value of such timer could be a predefined value configured by the wireless network operator or it could be calculated based on an artificial intelligence and machine learning tools which could set dynamically the value of that timer based on previous experiences with such dangerous incident event.

One main advantage of the fourth implementation technique is that when any type of dangerous incident occurs in an area that is covered partly or fully by a CSG cell, that CSG cell will be converted temporary into an open access cell allowing any UE that is not-registered to that CSG cell to be able to perform normal calls on that CSG cell.

In a fifth implementation technique, the system 102 may be configured to convert a CSG cell to an open access after an equipment failure. In the rest of the present disclosure, an equipment failure could be any hardware or software failure on the equipment or it could be a transmission link failure between that equipment and any other software or a hardware entity. As one main requirement of the fifth implementation technique, the equipment in question should have an interface to a UE which might be installed inside or outside the equipment and the role of that UE is to allow the equipment to communicate to a mobile wireless network. The first equipment represented by a network equipment/UE 108-1 that is implemented at one location, e.g. location X, and is connected, via what is called a transmission link, to a second equipment, the network equipment/UE 108-2, or to the server 106 via network 104, that is implemented at another location, e.g. location Y.

The equipment could be of any type, a first example, it could be any type of base station such as a radio base station. In a second example, it could be any type of routers such as an IP (Internet Protocol) router. In a third example, it could be a transmission switch where transmission cables are connected to it. In a fourth example it could be any type of wireless equipment.

Whatever is the type of the equipment, it should be able to handle any of the following three types of transmission link that are respectively denoted as primary link, a secondary link and a tertiary link. In one non-limited example of implementation, the primary link is a terrestrial link, the secondary link is a non-terrestrial link and the tertiary link is a UE to UE link. The components and the switch between these three types of links could be illustrated with the following examples.

In a first example, the primary link might be composed of two cables where one cable is used as an active transmission link and the other cable is used as a standby link. In a second example, the primary link might be composed of two links where the first one is a cable and the second one is a microwave and where when the cable link is used as an active link, then the microwave link is used as standby link and vice versa.

As the secondary link is a non-terrestrial link, e.g. a satellite communication, the equipment whatever is its nature, e.g. an IP router or a radio base station and the like, should be able to connect to the satellite communication via a satellite antenna which could be a standalone antenna or an antenna incorporated into the UE 108 that is connected to the equipment.

Based on the actual UE standards, when a first UE goes out of coverage it could use a second UE that is in coverage as a relay UE to connect to the mobile wireless network and perform a call. In the standards such UE to UE communication is called a sidelink communication. However, in the present disclosure the communication between two UEs is not limited to sidelink but could be any type of wireless communications such as Bluetooth, Near link, and the like. In the present disclosure, any of the actual standard UE to UE communication might be used as a third way to allow a communication between two equipment when both links, the primary and the secondary, between these two equipment fail.

In an embodiment of the fifth implementation technique, at each equipment, a new entity, denoted here as entity1, is used to switch between any of the above three types of transmission links. Entity1 could be a software entity or a hardware entity or a combination of both. We also consider that all the terrestrial transmission links are monitored by a software entity running on a workstation and it is denoted as OSS 118 terrestrial link. Whereas different satellite providers, such as satellite providers 1 and 2, each could be monitored and configured by a dedicated OSS. The OSS of all the satellite providers, the OSS of all terrestrial mobile wireless networks as well as the OSS of terrestrial link are all connected to each other and are part of OSS unit 118. Moreover, all these OSS are connected to entity1.

The fifth implementation might be composed of six steps as follows. In a first step, denoted as the initial step, a first equipment at location X is communicating with a second equipment at location Y via a terrestrial primary transmission link. In a second step, each time the primary link goes down between the two equipment, e.g. a cable between the two equipment was damaged due to an accident or a natural disaster, entity1 will switch to the secondary configured link which consists of a satellite communication in our example. The switch by entity1 could be triggered autonomously when the first transmission link goes down or it could be triggered by a command coming from a second entity such as the OSS of the terrestrial transmission link. Depending on whether the antenna of the satellite communication is also damaged or not, the third step or the fourth step is executed.

In case the antenna from the equipment to the satellite communication is not damaged, the third step of the fifth implementation technique is executed as follows: When the primary terrestrial link goes down, an alarm will be raised at the OSS of terrestrial link, e.g. denoted as OSS_terrestrial_operator1, and entity1 will switch to the secondary non-terrestrial transmission link and one of the following two scenarios will be implemented: If a satellite provider to which the equipment is registered to, e.g. denoted as satellite1, is available, then normal satellite communication is possible and no further action is required. Otherwise, if satellite1 is not available, then to let the UE, that is connected to the failed equipment, perform normal calls on any non-registered satellite network, e.g. satellite2, the following two actions are executed.

In a first action, the OSS_terrestrial_operator1 will send to the OSS of the satellite communication to which the equipment is not registered, e.g. denoted as OSS_satellite2, a notification containing information about the failure of the primary transmission between the two equipment. In addition, it sends the SIM card being used by the two equipment and optionally it sends the locations X and Y of the two equipment. In a second action, the OSS_satellite2 will send to the network 104 of satellite2 a notification containing a command to accept any call, including normal calls, from UEs that are not registered to satellite2 and where the call request should come only from the SIM cards of the two equipment or they could come from any UE at locations X and Y. In other words, the objective of the first and the second actions is to convert, temporary, a cell from satellite2, e.g. denoted as cell2_satellite2, which is considered as a CSG cell for unregistered UEs, from a CSG cell to an open access cell so that the unregistered UEs such as the one connected to the failed equipment could perform normal calls via satellite2 network.

The fourth step of the fifth implementation technique might be illustrated as follows: At this stage, entity1 has received a first alarm about the primary terrestrial link becoming faulty. When the antenna from the equipment to the satellite 120 may be damaged, e.g. due to a natural disaster, a second alarm will be raised at the OSS of satellite1, denoted here as OSS_satellite1, where the monitoring of the status of the satellites as well as their standalone satellite is performed. That second alarm will be sent from OSS_satellite1 to entity1. When entity1 has received the first and the second alarms, it will autonomously activate its tertiary transmission link which consists of using a nearby UE as a relay.

In a fifth step of the fifth implementation technique, the system 102 may perform the conversion from a CSG cell to an open access cell based on a tool that predicts equipment failure. Actually, in all industries it exists prediction tools which could predict the failure of any software or hardware entity. As another feature of the fifth implementation technique, rather than waiting for the equipment to fail in order to execute the conversion from a CSG cell to an open access cell, such conversion could be performed earlier that is at the time of outcome of the prediction tool. In other words, if at a first time t1 a prediction tool sends a notification that at a later time t2 the equipment will fail, then this new feature consists of executing the conversion from a CSG cell to an open access cell at time t1 so that when the time t2 arrives the move of the equipment from public cell to a CSG cell is quicker as the conversion is already done.

In a sixth step of the fifth implementation technique, a CSG cell, such as cell2_satellite2 mentioned in the third step and cell2 mentioned in the fourth step, will be reverted back from open access to its initial status as CSG cell either immediately after the equipment failure is ceased or after a timer has expired. The value of the timer could be calculated based on a predefined value configured by the wireless network operator or based on an artificial intelligence and machine learning tools which could set dynamically the value of that timer based on previous experience with similar equipment failure event.

In an embodiment, the network (104) may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. The network (104) may also include, by way of example but not limitation, one or more of a wireless network, a wired network, an internet, an intranet, a public network, a private network, a packet-switched network, a circuit-switched network, an ad hoc network, an infrastructure network, a Public-Switched Telephone Network (PSTN), a cable network, a cellular network, a satellite network, a fiber optic network, or some combination thereof.

FIG. 2 illustrates an exemplary representation (200) of the proposed system (102) for enabling migration of a UE to a CSG layer, in accordance with an embodiment of the present disclosure.

As illustrated, the system (102) may include one or more processors (202) that may be implemented as one or more microprocessors, microcomputers, microcontrollers, digital signal processors, central processing units, logic circuitries, and/or any devices that manipulate data based on operational instructions. Among other capabilities, the one or more processor(s) (202) may be configured to fetch and execute computer-readable instructions stored in a memory (204). The memory (204) may store one or more computer-readable instructions or routines, which may be fetched and executed to create or share the data units over a network service. The memory (204) may comprise any non-transitory storage device including, for example, volatile memory such as RAM, or non-volatile memory such as EPROM, flash memory, and the like.

In an embodiment, the system (102) may comprise an interface(s) (206). The interface(s) (206) may comprise a variety of interfaces, for example, interfaces for data input and output devices, referred to as I/O devices, storage devices, sensors, and the like. The interface(s) (206) may facilitate communication of the computing device (106) with various devices coupled to it. The interface(s) (206) may also provide a communication pathway for one or more components of the system (102). Examples of such components include, but are not limited to, processing engine(s) (208) and database (210).

In an embodiment, the one or more processors (202) may be implemented as a combination of hardware and programming (for example, programmable instructions) to implement one or more functionalities of the one or more processors (202). In examples described herein, such combinations of hardware and programming may be implemented in several different ways. For example, the programming for the one or more processors (202) may be processor-executable instructions stored on a non-transitory machine-readable storage medium and the hardware for the one or more processors (202) may comprise a processing resource (for example, one or more processors), to execute such instructions. In the present examples, the machine-readable storage medium may store instructions that, when executed by the processing resource, implement the one or more processors (202). In such examples, the system (102) may comprise the machine-readable storage medium storing the instructions and the processing resource to execute the instructions, or the machine-readable storage medium may be separate but accessible to the system (102) and the processing resource. In other examples, the one or more processors (202) may be implemented by electronic circuitry.

In an aspect, the database (210) may comprise data that may be either stored or generated as a result of functionalities implemented by any of the components of the processor (202) and/or the processing engines (208). In an embodiment, the database (210) may include data processed by any or all the components of the system (102). As an example but not limitation, the database (210) may include the at least one spatially tagged measurement sample corresponding to the predefined area which are fetched from the telecom core and stored for analysis.

In an exemplary embodiment, the processing engine(s) (208) of the system (102) may include, a data acquisition engine (212), a registration engine (214), a layer of CSG cells manager engine (216), a validation engine (218), a CSG to open access conversion engine (220), and other modules/engines (222), wherein the other modules/engines (222) may further include, without limitation, storage engine, computing engine, or signal generation engine.

In an embodiment, the data acquisition engine (212) may be configured to gather real-time network data, including signal strength, location information, and CSG cell proximity. The data acquisition engine 212 ensures that the system 102 may be aware of the UE's context for initiating migration.

In an embodiment, the registration engine 214 may be configured to manage the process of registering the UE 108 with the Closed Subscriber Group layer 114 by verifying its identity and subscription details against a central database. Successful registration is a prerequisite for accessing the CSG cell.

In an embodiment, the layer of CSG cells manager engine 216 may be configured to managing wrt first implementation technique the addition of a new layer of CSG cells comprises: group a multiple number of adjacent CSG cells under one layer of CSG cells, assign one or more functions and/or services to that layer, assign a frequency for each new layer of CSG cells, distribute the priority of the assigned frequencies among the layers of CSG cells based on the priority of each layer, stop wrt the second implementation technique broadcasting a CSG cell belonging to one layer of CSG cells when it becomes unavailable and re-broadcast that failed CSG cell whenever it is restored.

In an embodiment, the validation engine 218 may be configured to validate the UE's credentials, access permissions, and current registration status to confirm eligibility for migration. This engine also ensures that only authorized UEs can access the CSG layer.

In an embodiment, the CSG to open access conversion engine 220 may be configured to convert any CSG cell to an open access cell after the occurrence of some predefined events that comprises: The occurrence of a dangerous incident, an equipment failure and as a result of a prediction tool that predicts beforehand the occurrence of a dangerous incident or an equipment failure.

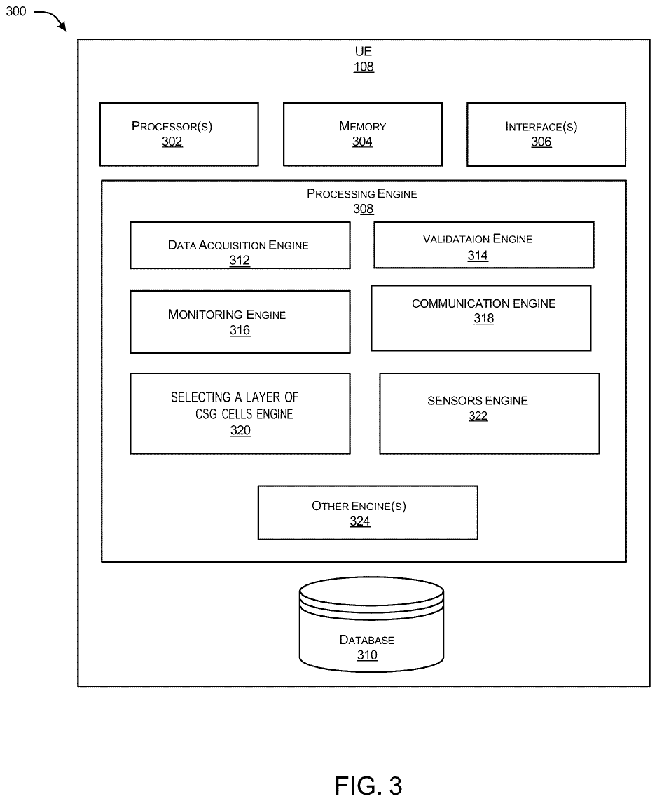

FIG. 3 illustrates an exemplary block diagram representation of a UE 108 for enabling migration of a UE to a CSG layer, in accordance with an embodiment of the present disclosure. The UE, as described in implementation technique 5, may function either as a standalone device used directly by a subscriber or as an integral component within other equipment. In the latter case, the primary purpose of the UE is to connect the equipment to a wireless network or to another UE via sidelink communication, particularly in scenarios such as equipment failure. Highlighting this distinction is important, as UEs are typically perceived as standalone devices for subscriber use.

In an aspect, the UE 108 may comprise a processor (302). The processor (302) may be an edge-based processor but not limited to it. The processor (302) may be implemented as one or more microprocessors, microcomputers, microcontrollers, digital signal processors, central processing units, logic circuitries, and/or any devices that process data based on operational instructions. Among other capabilities, the processor(s) (302) may be configured to fetch and execute computer-readable instructions stored in a memory (304) of the UE (106). The memory (304) may be configured to store one or more computer-readable instructions or routines in a non-transitory computer readable storage medium, which may be fetched and executed to create or share data packets over a network service. The memory (304) may comprise any non-transitory storage device including, for example, volatile memory such as RAM, or non-volatile memory such as EPROM, flash memory, and the like.

In an embodiment, the UE (108) may include an interface(s) (306). The interface(s) (306) may comprise a variety of interfaces, for example, interfaces for data input and output devices, referred to as I/O devices, storage devices, and the like. The interface(s) (306) may facilitate communication of the UE (108). Examples of such components include, but are not limited to, processing engine(s) (308) and a database (310).

The processing engine(s) (308) may be implemented as a combination of hardware and programming (for example, programmable instructions) to implement one or more functionalities of the processing engine(s) (308). In examples described herein, such combinations of hardware and programming may be implemented in several different ways. For example, the programming for the processing engine(s) (308) may be processor executable instructions stored on a non-transitory machine-readable storage medium and the hardware for the processing engine(s) (308) may comprise a processing resource (for example, one or more processors), to execute such instructions. In the present examples, the machine-readable storage medium may store instructions that, when executed by the processing resource, implement the processing engine(s) (308). In such examples, the UE (108) may comprise the machine-readable storage medium storing the instructions and the processing resource to execute the instructions, or the machine-readable storage medium may be separate but accessible to the UE (108) and the processing resource. In other examples, the processing engine(s) (308) may be implemented by electronic circuitry.

In an aspect, the database (310) may comprise data that may be either stored or generated as a result of functionalities implemented by any of the components of the processor (302) and/or the processing engines (308). Further, the database (310) may comprise the transmitted data packet, the data processed using one or more engines, the computed results, and the like.

In an exemplary embodiment, the processing engine(s) (308) of the user equipment (108) may include, a data acquisition engine (312), a validation engine (314), a monitoring engine (316), a communication engine (318), a selecting a layer of CSG cells engine 320, a sensors engine 322 and other engines (324), wherein the other engines (324) may further include, without limitation, storage engine, computing engine, or signal generation engine.

In an embodiment, the data acquisition engine 312 may collect information from the UE and the surrounding network, including signal strength, location, and network identifiers. It enables the UE to identify nearby CSG cells and determine their suitability for migration.

In an embodiment, the validation engine 314 may be responsible for verifying the credentials and registration status of the UE against the CSG cell's access control database. This ensures that only authorized UEs are allowed to migrate to the CSG layer, maintaining network security and integrity.

In an embodiment, the monitoring engine 316 may continuously observe network conditions, such as signal quality, interference levels, and UE activity. It helps in determining the optimal timing for migration and ensures stable connectivity during and after the transition to the CSG cell.

In an embodiment, the communication engine 318 may manage the exchange of messages between the UE, the public cell 112, and CSG cell. It handles migration commands, resource requests, and acknowledgment signals to ensure a seamless handover process without service disruption.

In an embodiment, the selecting a layer of CSG cells engine 320 may be configured to allow the UE to select a target layer of CSG cells among multiple existing layers of CSG cells based on setting, at the time of selecting that target layer, the priority of the frequency of that target layer as the highest frequency priority among all existing layers of CSG cells. The selecting a layer of CSG cells engine 320 may require the UE having access to a new software entity, e.g. via an icon on that UE or via a mobile application, that allows the subscriber to select a target layer of CSG cells in order to benefit from its services.

In an embodiment, the sensors engine 322 may be configured to manage alarms coming from sensors. The sensors might be implemented at the UE itself or they might be located outside the UE but they are connected to sensors engine via interface 306. Moreover, the sensors engine 322 might include sub-thresholds of a sensor that when reached it could generate a sensor alarm. Furthermore, it might include a sensor alarm prediction tool that could tell when a sensor sub-threshold or a sensor threshold might be reached and hence generates an early sensor alarm once the prediction is made.

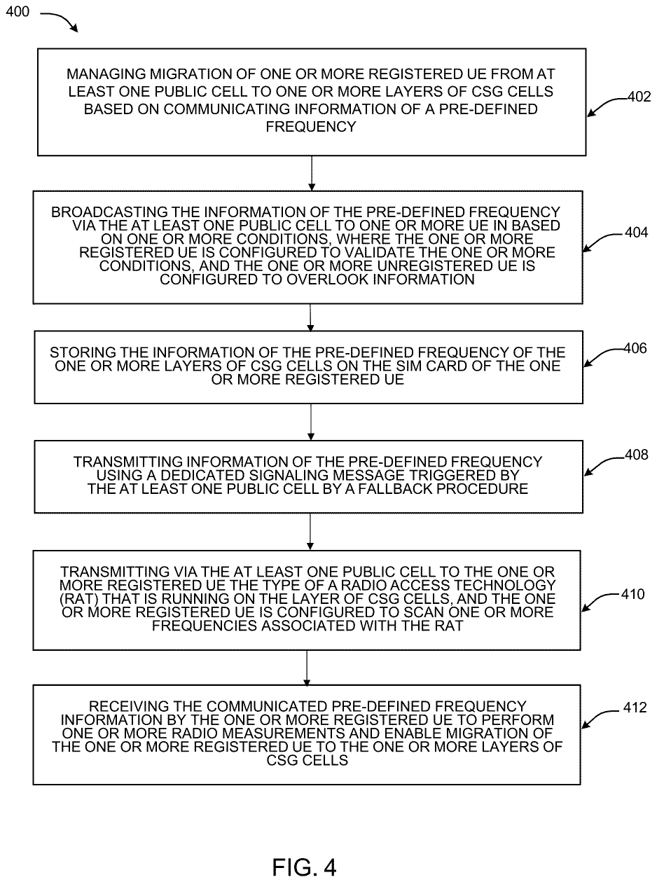

FIG. 4 illustrates an exemplary flow diagram of a method 400 for enabling migration of UE to CSG layer, in accordance with an embodiment of the present disclosure.

In an embodiment, the method 400 for enabling migration of UE 108 to CSG layer 114 may include a plurality of steps 402-412. The method 400 may be implemented by the system 102.

At step 402, managing migration of one or more registered UE from at least one public cell 112 to one or more layers of CSG cells based on communicating information of a pre-defined frequency comprises steps 404-412.

At step 404, broadcasting the information of the pre-defined frequency via the at least one public cell 112 to one or more UE in based on one or more conditions. The one or more registered UE is configured to validate the one or more conditions, and the one or more unregistered UE is configured to overlook information.

At step 406, storing the information of the pre-defined frequency of the one or more layers of CSG cells on the SIM card of the one or more registered UE.

At step 408, transmitting information of the predefined frequency using a dedicated signaling message triggered by the at least one public cell 112 by a fallback procedure.

At step 410, transmitting via the at least one public cell to the one or more registered UE the type of a RAT that is running on the layer of CSG cells, and the one or more registered UE is configured to scan one or more frequencies associated with the RAT.

At step 412, receiving the communicated pre-defined frequency information by the one or more registered UE to perform one or more radio measurements and enable migration of the one or more registered UE to the one or more layers of CSG cells.

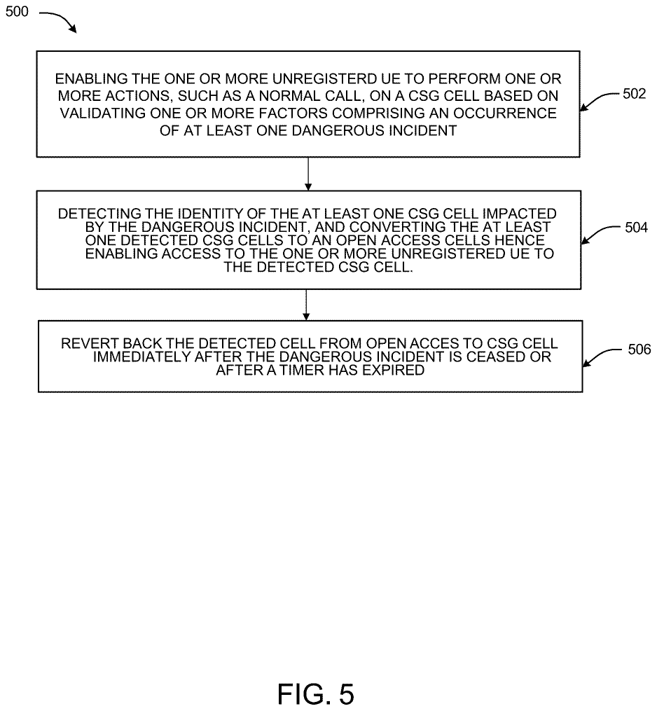

FIG. 5 illustrates an exemplary representation of a flow diagram of a method for converting the CSG cell into an open cell at the occurrence of dangerous incident, in accordance with an embodiment of the present disclosure.

In an embodiment, the method 500 for converting the CSG cell into an open cell at the occurrence of dangerous incident may include a plurality of steps 502-504. The method 500 may be implemented by the system 102.

At step 502, enabling the one or more unregistered UE 108 to perform one or more actions, such as a normal call, based on validating one or more factors comprising an occurrence of at least one dangerous incident.

At step 504, detecting the identity of the at least one CSG cell impacted by the dangerous incident, and converting the at least one detected CSG cells to an open access cells and enabling access to the one or more unregistered UE 108. The occurrence of any dangerous incident is detected using an Operations and Support System (OSS) coupled to an external server. The external server may include at least one dangerous incident received from one or more sources comprising one or more sensors, a natural disaster monitoring system, a call center. The one or more sensors is coupled to at least one of a human body, a terrestrial geographical location, a non-terrestrial object. The sensor comprises: sending a sensor alarm notification after a dangerous incident has occurred and sending an early sensor alarm notification such as when a sub-threshold of the sensor alarm is reached or based on a sensor alarm prediction tool. The natural disaster monitoring system comprises a weather station and a seism monitoring center. The call center comprises any call coming from a subscriber who is reporting the occurrence of an accident. The conversion of the at least one detected CSG cells to the open access cell is either executed for all unregistered UEs being served by the detected CSG cells or for the one or more unregistered UEs selected based on the SIM and a terrestrial geographical location.

At step 506, the detected CSG cell is reverted back from the open access to a CSG cell immediately after the dangerous incident is ceased or after a timer has expired and where the value of the timer is calculated based on a predefined value configured by the wireless network operator or based on an artificial intelligence technique to set dynamically the value of that timer based on previous experience with such dangerous incident event.

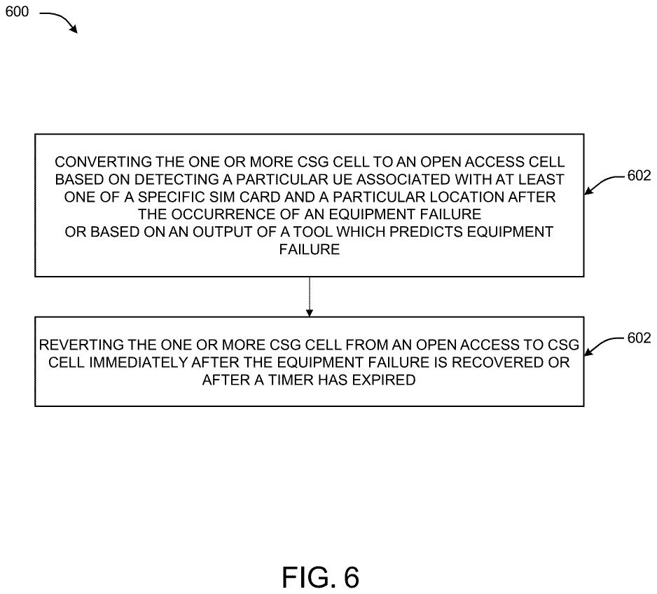

FIG. 6 illustrates an exemplary representation of a flow diagram of a method 600 for converting a CSG cell to an open access cell after an equipment failure, in accordance with an embodiment of the present disclosure.

In an embodiment, the method 600 converting a CSG cell to open access cell after an equipment failure may include a plurality of steps 602-604. The method 600 may be implemented by the system 102.

At step 602, converting the one or more CSG cell to an open access cell based on detecting a particular UE associated with at least one of a specific SIM card and a particular location after the occurrence of an equipment failure or based on an output of a tool which predicts equipment failure event. The equipment failure could be any hardware or software failure on the equipment or it could be a transmission link failure between that equipment and any other software or a hardware entity. The equipment comprises a radio base station, an internet protocol router, a switch, a router and a transmission device. Further, inside the equipment, or connected to it, is implemented a UE that has an access to a terrestrial wireless network and to a non-terrestrial mobile wireless network. It is via that UE that the equipment could access a CSG cell after the equipment failure.

At step 602, reverting the one or more CSG cell from an open access to CSG cell immediately after the equipment failure is recovered or after a timer has expired and where the value of the timer is calculated based on a predefined value configured by the wireless network operator or based on an artificial intelligence technique to set dynamically the value of the timer based on previous experience based on the equipment failure event.

While considerable emphasis has been placed herein on the preferred embodiments, it will be appreciated that many embodiments can be made and that many changes can be made in the preferred embodiments without departing from the principles of the invention. These and other changes in the preferred embodiments of the invention will be apparent to those skilled in the art from the disclosure herein, whereby it is to be distinctly understood that the foregoing descriptive matter to be implemented merely as illustrative of the invention and not as limitation.

### Advantages of the Present Disclosure

The present disclosure provides a system and a method for enabling migration of a UE to a CSG layer.

The present disclosure allows a mobile wireless operator to create a new layer of CSG cells on top of its existing public cell where registered UEs could access the service of the layer of CSG cell in return of certain fees while that same layer of CSG cells looks transparent for unregistered UEs.

The present disclosure provides a method that allows a subscriber to switch from a first layer to second layer based on based on a software icon, the artificial intelligence technique, and a mobile application and where the first and the second layers could be any of a public cell and a layer of CSG cells.

The present disclosure allows an unregistered UE to access a layer of CSG cells after the occurrence of a dangerous incident that could impact subscriber's life.

An object of the present disclosure is to allow an unregistered UE, based on its SIM card and geographical location, to access a layer of CSG cells after an equipment failure.

1. A system (102) for enabling migration of User Equipment (UE) to Closed Subscriber Group (CSG) layer, the system (102) comprising:
at least one public cell (112);
one or more layer of CSG cells (114) coupled to the at least one public cell (112), and configured to provide a plurality of services to one or more User Equipment's (UE) (108) within one or more layer of CSG cells (114);
the one or more UE (108) communicatively coupled to the at least one public cell (112) and the one or more layer of CSG cells (114), and configured to utilize one or more network resources and access the plurality of services to perform one or more operations, wherein the one or more UE (108) comprises at least one of the one or more registered UE (108) and the one or more unregistered UE (108); and
one or more processors (202) coupled with a memory (204), wherein said memory (204) stores instructions which when executed by the one or more processors (202) causes the system (102) to:
manage migration of the one or more registered UE (108) from the at least one public cell (112) to the one or more layer of CSG cells (114) based on communicating information of a pre-defined frequency comprises:
broadcast the information of the pre-defined frequency via the at least one public cell (112) to the one or more UE (108) based on one or more conditions, wherein the one or more registered UE (108) is configured to validate the one or more conditions, and the one or more unregistered UE (108) is configured to overlook the information;
store the information of the pre-defined frequency of the one or more layer of CSG cells (114) on the Subscriber Identity Module (SIM) card of the one or more registered UE (108);
transmit the information of the pre-defined frequency to the one or more registered UE (108) by using a dedicated signalling message triggered by the at least one public cell (112) by a fallback procedure;
transmit via the at least one public cell (112) to the one or more registered UE (108) the type of a Radio Access Technology (RAT) that is running on the layer of CSG cells, and the one or more registered UE is configured to scan one or more frequencies associated with the RAT; and
receive the communicated pre-defined frequency information by the one or more registered UE (108) to perform one or more radio measurements and enable migration of the one or more registered UE to the one or more layer of CSG cells (114).

2. The system (102) as claimed in claim 1, wherein the one or more layer of CSG cells (114) comprise one or more micro-CSG cells positioned adjacent to each other to provide a wide range of radio coverage to the one or more registered UE,
wherein information of the pre-defined frequency comprises a value of frequency used by each of the one or more micro-CSG cells belonging to the one or more layer of CSG cells (114) and the priority of the pre-defined frequency,
wherein a CSG cell is running on one or more types of Radio Access Technology (RAT) and belong to a terrestrial or to a non-terrestrial wireless network,
wherein the one or more UE (108) is configured to registered to a multiple number of the one or more layer of CSG cells (114), and detect the identity of each layer based on the information stored on the SIM card.

3. The system (102) as claimed in claim 1, wherein the system (102) is configured to:
broadcast the information of the one or more layer of CSG cells (114) by using the at least one public cell (112) based on:
a count of the one or more layer of CSG cells (114) available, the identity of each layer of one or more micro-CSG cells and information related to the pre-defined frequency associated with the one or more layer of CSG cells (114);
the priority of the pre-defined frequency of the one or more layer of CSG cells (114) is higher than the priority of the pre-defined frequency of the at least one public cell (112),
wherein the one or more registered UE (108) is configured to access content of the broadcasted information to migrate from the at least one public cell (112) to the one or more CSG layer of CSG cells, wherein the one or more unregistered UE (108)
is configured to overlook the content of the new broadcasted information.

4. The system (102) as claimed in claim 1, wherein the system is configured to:
broadcast the information by using the at least one public cell (112) based on the priority of the pre-defined frequency of the one or more layer of CSG cells (114) is higher than the priority of the pre-defined frequency of the at least one public cell (112); and
store the information of the pre-defined frequency used by each of the one or more layer of CSG cells (114) on the SIM card of the one or more registered UE registered (108),
wherein the one or more registered UE (108) is configured to:
collect a pre-defined frequency information pertaining to a target CSG layer, and store the pre-defined frequency information in a UE database during a first time access and perform one or more radio measurements and enable migration of the one or more registered UE (108) to the one or more layer of CSG cell (114).

5. The system (102) as claimed in claim 1, wherein the system is configured to:
broadcast the information of the one or more layer of CSG cells (114) by using the at least one public cell (112) based on:
a count of the one or more layers of CSG cells (114) available, the identity of each layer of CSG cells and information related to the pre-defined frequency associated with the one or more layer of CSG cells (114); and
the priority of the pre-defined frequency of the one or more layer of CSG cells (114) is lower than the priority of the pre-defined frequency of the at l east one public cell (112),
wherein the one or more registered UE (108) is configured to transmit a call request signal to the at least one public cell (112) to access the target CSG layer, the at least one public cell (112) rejects the call request signal comprising information related to the pre-defined frequency the RAT of the target layer of CSG cells.

6. The system (102) as claimed in claim 1, wherein the system (102) is configured to: broadcast the information of the one or more layer of CSG cells by using the at least one public cell (112) based on:
a count of the one or more layers of CSG cells (114) available, the identity of each layer of CSG cells and information related to the pre-defined frequency associated with the one or more layer of CSG cells;
the priority of the pre-defined frequency of the one or more layers of CSG cells (114) is higher than the priority of the pre-defined frequency of the at least one public cell (112); and
communicate to the UE the RAT of each available layer of the one or more layer of CSG cells (114) by broadcasting using the at least one public cell (112) or by storing the value on the SIM cards of each of the one or more registered UE to a layer of CSG cells,
wherein the information of the pre-defined frequency is deduced by the one or more registered UE (108) based on scanning the one or more frequencies associated with the RAT to detect the suitable cell on the one or more layer of CSG cells (114) and then store the pre-defined frequency associated with the information on the UE database.

7. The system (102) as claimed in claim 1, wherein the system (102) is configured to:
whenever the one or more CSG cell belonging to a layer of CSG cells (114) is completely overlapping on the at least one public cell (112) the system (102) comprises at least one of a first scenario and a second scenario,
wherein, the first scenario comprises broadcasting the multiple number of the one or more layer CSG cells associated with the identity of the one or more micro-CSG cells by the at least one public cell (112), wherein:
each time the one or more overlapping CSG cell becomes unavailable, the at least one public cell (112) is configured to stop broadcasting the identity associated with the one or more layer of CSG cells, and decreases the value of the multiple number of the one or more available layers of CSG cells by one count; and
each time the one or more overlapping CSG cell becomes available, the at least one public cell (112) is configured to broadcasting the identity associated with the one or more layer of CSG cells and increase the value of the multiple number of the one or more available layers of CSG cells by one count,
wherein, the second scenario comprises not broadcasting the multiple number of the one or more layer of CSG cells associated with the identity of the one or more micro-CSG cells by the at least one public cell (112), wherein:
the one or more registered UE (108) is configured to access the one or more layer of CSG cells from the at least one public layer based on the signaling message associated with a timer; and
the one or more registered UE (108) is configured to predict a faulty state of the one or more layer of CSG cells based on encountering overlapping by using an Artificial Intelligence (AI) technique, and then search for the one or more layer CSG cells which is suitable based on the pre-defined frequency over a predefined period of time.

8. The system (102) as claimed in claim 1, wherein the system (102) is configured to:
enable migration of the one or more registered UE (108) from a first CSG layer to a second CSG layer based on the priority of the pre-defined frequency set by the one or more registered UE (108), wherein the priority of the pre-defined frequency of the second CSG layer is set higher than the priority of the frequency used on the first CSG layer.

9. The system (102) as claimed in claim 8, wherein the UE (108) is configured to:
enable the triggering of the priority of the pre-defined frequency comprises based on a software icon, the artificial intelligence technique, and a mobile application,
wherein the software icon on the one or more registered UE (108) associated with the at least one subscriber to access the plurality of services associated with the one or more layer of CSG cells,
wherein the artificial intelligence technique implemented at the one or more registered UE to monitor the at least one subscriber's activity on each of the one or more layers of CSG cells,
wherein the mobile application comprises the software icon for activating the one or more layers of selected CSG cells which is activated from the one or more layers of available CSG cells along with a time-frame.

10. The system (102) as claimed in claim 1, wherein the system (102) is configured to:
enable the one or more unregistered UE (108) to perform one or more actions, such as a normal call, based on validating one or more factors comprising an occurrence of at least one dangerous incident, a detection of the identity of the at least one CSG cell impacted by the dangerous incident, and a conversion of the at least one detected CSG cells to an open access cells and enabling access to the one or more unregistered UE (108).

11. The system (102) as claimed in claim 10, wherein the occurrence of any dangerous incident is detected using an operations and support unit coupled to an external server,
wherein the external server comprises at least one dangerous incident received from one or more sources comprising one or more sensors, a natural disaster monitoring system, a call center,
wherein the conversion of the at least one detected CSG cells to the open access cell is either executed for all unregistered UEs (108) being served by the detected CSG cells or for the one or more unregistered UEs (108) selected based on the SIM and a terrestrial geographical location,
wherein the detected CSG cell is reverted back from the open access to a CSG cell immediately after the dangerous incident is ceased or after a timer has expired and where the value of the timer is calculated based on a predefined value configured by the wireless network operator or based on an artificial intelligence technique to set dynamically the value of that timer based on previous experience with such dangerous incident event.

12. The system (102) as claimed in claim 11, wherein the one or more sensors is coupled to at least one of a human body, a terrestrial geographical location, a non-terrestrial object,
wherein the sensor comprises: sending a sensor alarm notification after a dangerous incident has occurred and sending an early sensor alarm notification such as when a sub-threshold of the sensor alarm is reached or based on a sensor alarm prediction tool,
wherein the natural disaster monitoring system comprises a weather station and a seism monitoring center,
wherein the call center comprises any call coming from a subscriber who is reporting the occurrence of an accident.

13. The system (102) as claimed in claim 1, wherein the system (102) is configured to:
convert the one or more CSG cell to an open access cell based on detecting a particular UE (108) associated with at least one of a specific SIM card and a particular location after the occurrence of an equipment failure or based on an output of a tool which predicts equipment failure event,
wherein the equipment comprises a radio base station, an internet protocol router, a switch, a router and a transmission device,
wherein inside the equipment, or connected to it, is implemented using the UE (108) with an access to a terrestrial wireless network and to a non-terrestrial mobile wireless network,
revert back the one or more CSG cell from the open access to CSG cell immediately after the equipment failure is recovered or after a timer has expired and where the value of the timer could be calculated based on the predefined value configured by the wireless network operator or based on an artificial intelligence technique to set dynamically the value of that timer based on previous experience with such equipment failure event.

14. The system (102) as claimed in claim 13, wherein the access to a terrestrial wireless network and to a non-terrestrial mobile wireless network is direct from the UE (108) to the base station over the air interface and indirect that is from the UE (108) to the base station via a second UE that is used as a relay,
wherein the connection of the equipment with the terrestrial wireless network comprises an incorporated UE, a fiber optical cable, a coaxial cable, an Ethernet cable, and a microwave device, wherein the connection of the equipment with the non-terrestrial wireless network comprises an incorporated UE (108) and an antenna for a satellite (120).

15. A method (400) for enabling migration of UE to CSG layer by a system (102) as claimed in claim 1, the method (400) comprising the steps of:
managing, by the system (102), migration of one or more registered UE (108) from at least one public cell (112) to one or more layers of CSG cells (114) based on communicating information of a pre-defined frequency comprises:
broadcasting, by the system (102), the information of the pre-defined frequency via the at least one public cell (112) to one or more UE (108) is based on one or more conditions, wherein the one or more registered UE (108) is configured to validate the one or more conditions, and the one or more unregistered UE (108) is configured to overlook information;
storing, by the system (102), the information of the pre-defined frequency of the one or more layers of CSG cells on the SIM card of the one or more registered UE (108);
transmitting, by the system (102), using a dedicated signaling message triggered by the at least one public cell (112) by a fallback procedure;
transmitting, by the system (102), via the at least one public cell (112) to the one or more registered UE the type of a RAT that is running on the layer of CSG cells (114), and the one or more registered UE is configured to scan one or more frequencies associated with the RAT; and
receiving, by the system (102), the communicated pre-defined frequency information by the one or more registered UE (108) to perform one or more radio measurements and enable migration of the one or more registered UE (108) to the one or more layers of CSG cells (114).

16. The method (500) as claimed in claim 15, wherein the method (500) comprises the steps of:
enabling, by the system (102), the one or more UE (108) to perform one or more actions, such as a normal call, based on validating one or more factors comprising an occurrence of at least one dangerous incident; and
detecting, by the system (102), the identity of the at least one CSG cell impacted by the dangerous incident, and converting the at least one detected CSG cells to an open access cells and enabling access to the one or more UE (108),
wherein the occurrence of any dangerous incident is detected using an operations and support unit coupled to an external server,
wherein the external server comprises at least one dangerous incident received from one or more sources comprising one or more sensors, a natural disaster monitoring system, a call center,
wherein the one or more sensors is coupled to at least one of a human body, a terrestrial geographical location, a non-terrestrial object,
wherein the natural disaster monitoring system comprises a weather station and a seism monitoring center,
wherein the call center comprises any call coming from a subscriber who is reporting the occurrence of an accident,
wherein the conversion of the at least one detected CSG cells to the open access cell is either executed for all unregistered UE (108) being served by the detected CSG cells or for the one or more unregistered UE (108) selected based on the SIM and a terrestrial geographical location,
wherein the detected CSG cell is reverted back from the open access to a CSG cell immediately after the dangerous incident is ceased or after a timer has expired and where the value of the timer is calculated based on a predefined value configured by the wireless network operator or based on an artificial intelligence technique to set dynamically the value of that timer based on previous experience with such dangerous incident event.

17. The method (600) as claimed in claim 15, wherein the method (600) comprises the steps of:
converting, by the system (102), of the one or more CSG cell to an open access cell based on detecting a particular UE (108) associated with at least one of a specific SIM card and a particular location after the occurrence of an equipment failure or based on an output of a tool which predicts equipment failure event,
wherein the equipment comprises a radio base station, an internet protocol router, a switch, a router and a transmission device,
wherein inside the equipment, or connected to it, is implemented a UE (108) that has an access to a terrestrial wireless network and to a non-terrestrial mobile wireless network,
reverting, by the system (102), the one or more CSG cell from an open access to CSG cell immediately after the equipment failure is recovered or after a timer has expired and where the value of the timer is calculated based on a predefined value configured by the wireless network operator or based on an artificial intelligence technique to set dynamically the value of the timer based on previous experience based on the equipment failure event.

18. The method as claimed in claim 17, wherein the access to a terrestrial wireless network and to a non-terrestrial mobile wireless network is direct from the UE (108) to the base station over the air interface and indirect that is from the UE (108) to the base station via a second UE (108) used as a relay,
wherein the connection of the equipment with the terrestrial wireless network comprises an incorporated UE (108), a fiber optical cable, a coaxial cable, an Ethernet cable, and a microwave device, wherein the connection of the equipment with the non-terrestrial wireless network comprises an incorporated UE (108) and an antenna for a satellite (120).
